(19) United States
(12) Patent Application Publication
(10) Pub. No.: US 2026/0197245 A1
(43) Pub. Date: Jul. 9, 2026

(54) PROTOCOLS AND SIGNALING FOR ARTIFICIAL INTELLIGENCE AND MACHINE LEARNING MODEL PERFORMANCE MONITORING

(71) Applicant: QUALCOMM Incorporated, San Diego, CA (US)

(72) Inventors: Hamed PEZESHKI, San Diego, CA (US); Tianyang BAI, Mountain View, CA (US); Qiaoyu LI, Beijing (CN); Tao LUO, San Diego, CA (US)

(21) Appl. No.: 18/874,675

(22) PCT Filed: Aug. 11, 2023
(86) PCT No.: PCT/CN2023/112513

§ 371 Date: Dec. 13, 2024

(30) Foreign Application Priority Data
Aug. 12, 2022 (WO) PCT/CN2022/112010

(51) Int. Cl. H04L 41/16; H04B 7/06; H04W 76/18

(52) U.S. Cl. CPC H04L 41/16; H04B 7/06952; H04W 76/18

(57) ABSTRACT

Wireless communication devices, systems, and methods related to monitoring the performance of artificial intelligence (AI) and/or machine learning (ML) models, including associated protocols and signaling, are provided. For example, a method of wireless communication performed by a user equipment (UE) can include receiving a machine learning (ML) model monitoring configuration; evaluating one or more values associated with a prediction of a ML model to one or more measured values based at least in part on the ML model monitoring configuration; and transmitting, in response to detecting a failure of the ML model based on the evaluating, an indication of the failure of the ML model.

### CROSS-REFERENCE TO A RELATED APPLICATION

The present application claims priority to and the benefit of International PCT Patent Application No. PCT/CN2022/112010, filed Aug. 12, 2022, the disclosure of which is referenced herein in its entirety as if fully set forth below and for all applicable purposes.

### TECHNICAL FIELD

This application relates to wireless communication systems, and more particularly to methods—and associated devices and systems—for monitoring the performance of artificial intelligence (AI) and/or machine learning (ML) models, including associated protocols and signaling.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

To meet the growing demands for expanded mobile broadband connectivity, wireless communication technologies are advancing from the long term evolution (LTE) technology to a next generation new radio (NR) technology, which may be referred to as 5th Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHZ to about 6 GHZ, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

In a wireless communication network, a BS may communicate with a UE in an uplink direction and a downlink direction. The radio frequency channel through which the BS and the UE communicate may have several channel properties that are considered for proper channel performance. The BS and UE may perform channel sounding to better understand these channel properties by measuring and/or estimating various parameters of the channel, such as delay, path loss, absorption, multipath, reflection, fading, doppler effect, among others. These channel measurements can also be used for channel estimation and channel equalization.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a user equipment (UE) includes receiving a machine learning (ML) model monitoring configuration; evaluating one or more values associated with a prediction of a ML model to one or more measured values based at least in part on the ML model monitoring configuration; and transmitting, in response to detecting a failure of the ML model based on the evaluating, an indication of the failure of the ML model. Associated devices, systems, means, and/or non-transitory computer readable media having one or more instructions for execution by one or more processors of a UE are also provided.

In an additional aspect of the disclosure, a method of wireless communication performed by a network unit includes transmitting, to a user equipment (UE), a machine learning (ML) model monitoring configuration, wherein the ML model monitoring configuration enables the UE to detect a failure of a ML model based on one or more measured values; and receiving, from the UE, an indication of a failure of the ML model based on the ML model monitoring configuration. Associated devices, systems, means, and/or non-transitory computer readable media having one or more instructions for execution by one or more processors of a network unit are also provided.

In an additional aspect of the disclosure, a user equipment (UE) includes a memory device; a transceiver; and a processor in communication with the processor and the transceiver, wherein the UE is configured to: receive a machine learning (ML) model monitoring configuration; evaluate one or more values associated with a prediction of a ML model to one or more measured values based at least in part on the ML model monitoring configuration; and transmit, in response to detecting a failure of the ML model based on the evaluating, an indication of the failure of the ML model.

In an additional aspect of the disclosure, a network unit includes a memory device; a transceiver; and a processor in communication with the processor and the transceiver, wherein the network unit is configured to: transmit, to a user equipment (UE), a machine learning (ML) model monitoring configuration, wherein the ML model monitoring configuration enables the UE to detect a failure of a ML model based on one or more measured values; and receive, from the UE, an indication of a failure of the ML model based on the ML model monitoring configuration.

Other aspects and features of the present invention will become apparent to those of ordinary skill in the art, upon reviewing the following description of specific, exemplary aspects of the present invention in conjunction with the accompanying figures. While features of the present invention may be discussed relative to certain aspects and figures below, all aspects of the present invention can include one or more of the advantageous features discussed herein. In other words, while one or more aspects may be discussed as having certain advantageous features, one or more of such features may also be used in accordance with the various aspects of the invention discussed herein. In similar fashion, while exemplary aspects may be discussed below as device, system, or method aspects, it should be understood that such exemplary aspects can be implemented in various devices, systems, and methods.

### BRIEF DESCRIPTION OF THE DRAWINGS

FIG. 1 illustrates a wireless communication network according to one or more aspects of the present disclosure.

FIG. 2 illustrates a diagram of an example disaggregated base station architecture according to one or more aspects of the present disclosure.

FIG. 3 illustrates a time domain beam prediction scheme according to some aspects of the present disclosure.

FIG. 4 illustrates a spatial domain beam prediction scheme according to some aspects of the present disclosure.

FIG. 5 illustrates a spatial domain beam prediction scheme according to one or more aspects of the present disclosure.

FIG. 6 illustrates a signaling diagram for a machine learning (ML) model monitoring scheme according to one or more aspects of the present disclosure.

FIG. 7 illustrates a flow chart of a ML model monitoring scheme according to one or more aspects of the present disclosure.

FIG. 8 illustrates a block diagram of a user equipment (UE) according to one or more aspects of the present disclosure.

FIG. 9 illustrates a block diagram of a network unit according to one or more aspects of the present disclosure.

FIG. 10 illustrates a flow diagram of a wireless communication method according to some aspects of the present disclosure.

FIG. 11 illustrates a flow diagram of a wireless communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some aspects, well-known structures and components are shown in block diagram form in order to avoid obscuring such concepts.

This disclosure relates generally to wireless communications systems, also referred to as wireless communication networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For instance, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an Ultra-high density (e.g., ~1M nodes/km²), ultra-low complexity (e.g., ~10s of bits/sec), ultra-low energy (e.g., ~10+years of battery life), and deep coverage with the capability to reach challenging locations; (2) including mission-critical control with strong security to safeguard sensitive personal, financial, or classified information, ultra-high reliability (e.g., ~99.9999% reliability), ultra-low latency (e.g., ~1 ms), and users with wide ranges of mobility or lack thereof; and (3) with enhanced mobile broadband including extreme high capacity (e.g., ~10Tbps/km ² ), extreme data rates (e.g., multi-Gbps rate, 100+Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For instance, in various outdoor and macro coverage deployments of less than 3GHz FDD/TDD implementations, subcarrier spacing may occur with 15 kHz, for instance over 5, 10, 20 MHz, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mm Wave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For instance, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink (UL)/downlink (DL) scheduling information, data, and acknowledgement in the same subframe. The self-contained integrated subframe supports communications in unlicensed or contention-based shared spectrum, adaptive UL/DL that may be flexibly configured on a per-cell basis to dynamically switch between UL and DL to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For instance, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For instance, a method may be implemented as part of a system, device, apparatus, and/or as instructions stored on a computer readable medium for execution on a processor or computer. Furthermore, an aspect may comprise at least one element of a claim.

Aspects of the present disclosure allow a UE and/or network unit to monitor the performance of one or more machine-learning (ML) models, including ML models for beam prediction. A wireless channel between the network (e.g., a BS) and a UE may vary over time. The BS may configure a set of beams for the UE, which at any point of time may use one or two serving beams to receive DL transmissions from or transmit UL transmissions to the BS. The BS and the UE may keep track of the serving beam(s) as well as candidate beams. For example, the UE may perform one or more measurements of one or more reference signals configured for the UE and may include the one or more measurements in a channel state information (CSI) report. If a serving beam fails, the BS may reconfigure the UE to use of the candidate beams. Candidate beams may be regularly updated because the channel quality between the BS and the UE may change over time. It may be desirable for the UE update the serving beam(s) according to the channel state. The UE may report the link quality of the serving beam(s) and the candidate beams in a CSI report to the BS, and the BS may process the CSI report and determine whether the UE's serving beam(s) or candidate beam(s) should be reconfigured. If the quality of a beam falls below a threshold, the BS may reconfigure a beam of the UE's serving beam(s) or candidate beam(s). The BS may configure the threshold. Based on the determination, the BS may transmit a command to reconfigure the UE's serving beam(s) and/or candidate beam(s) in response to the CSI report.

The BS may configure the UE to periodically report the CSI report to the BS. The CSI report may include, for example, channel quality information (CQI) and/or reference signal received power (RSRP). CQI is an indicator carrying information on the quality of a communication channel. The BS may use the CQI to assist in downlink (DL) scheduling. The BS may use the RSRP to manage beams in multi-beam operations. The UE may perform different combinations of measurements for inclusion in the CSI report. Accordingly, the UE may transmit a CSI report including the CQI but not the RSRP, a CSI report including the RSRP but not the CQI, and/or a CSI report including both the CQI and the RSRP.

In 5G NR, machine learning (ML) algorithms are being implemented to assist cellular network performance. These ML algorithms may include neural networks that are implemented at different types of nodes within a wireless communication network. For example, the neural networks may be implemented at a single node (e.g., UE/BS/central cloud server) or may be distributed over multiple nodes. The ML algorithms may be implemented to assist with different functions and/or modules among the nodes of the wireless communication network. In various aspects, the neural network may be implemented as a convolutional neural network (CNN), a recurrent neural network (RNN), a deep convolutional network (DCN), among others.

At each node implemented with one or more ML algorithms, the ML algorithms may interact with different layers within the node. The ML algorithms may interact with one of the physical layer (PHY), the media access control (MAC) layer or upper layers (e.g., application layer) in some instances, or with multiple layers in other instances. These ML algorithms may involve various ML-related data transfers between different layers of different nodes (e.g., UE, BS, central cloud server). The ML algorithms may be trained with training datasets that are produced through periodic and/or aperiodic data collection at one or more nodes. In various aspects, measurement data collection serves as input to the ML modules. The operation of these ML algorithms at the different nodes may be used for ML model parameter transfer and/or update. The ML model framework within the wireless communication network has the capability to send feedback signals and/or reports between the different nodes. In various aspects, the UE may feedback channel measurements that are indicative of the ML model prediction accuracy. For example, the measurement data collection by the UE may be sent to the BS and/or central cloud server with a report may indicate that the ML model is producing prediction errors, thus indicative that the ML model has failed and/or requires updating.

In various aspects, the UE may include different ML algorithms on board to predict channel properties for a future use of that channel. For example, the machine learning-based network may be implemented by a channel property prediction network to predict one or more properties of a channel and/or one or more beam parameters. In some aspects, the ML algorithms are tasked to predict what transmission beam(s) to use for the BS and/or reception beam(s) to use for the UE. For example, the machine learning-based network may be implemented by a beam selection prediction network to predict the BS transmission beam(s) and/or the UE reception beam(s).

The present disclosure provides techniques for a UE and/or network unit to monitor the performance of one or more machine-learning (ML) models, including ML models for beam prediction. In this regard, the UE and/or network unit can stop the ML model, initiate a retraining of the ML model, and/or adjust one or more operating parameters of the ML model upon detecting an event, such as a failure of the ML model. Aspects of the present disclosure provide protocols and signaling to allow the UE and the network unit to be coordinated as the operation (or non-operation) of a ML model. As described herein, in addition to the coordination benefits aspects of the present disclosure provide improved network efficiency, improved allocation of network resources, reduced power consumption by the UEs and/or the network units, and/or improved utilization of ML models.

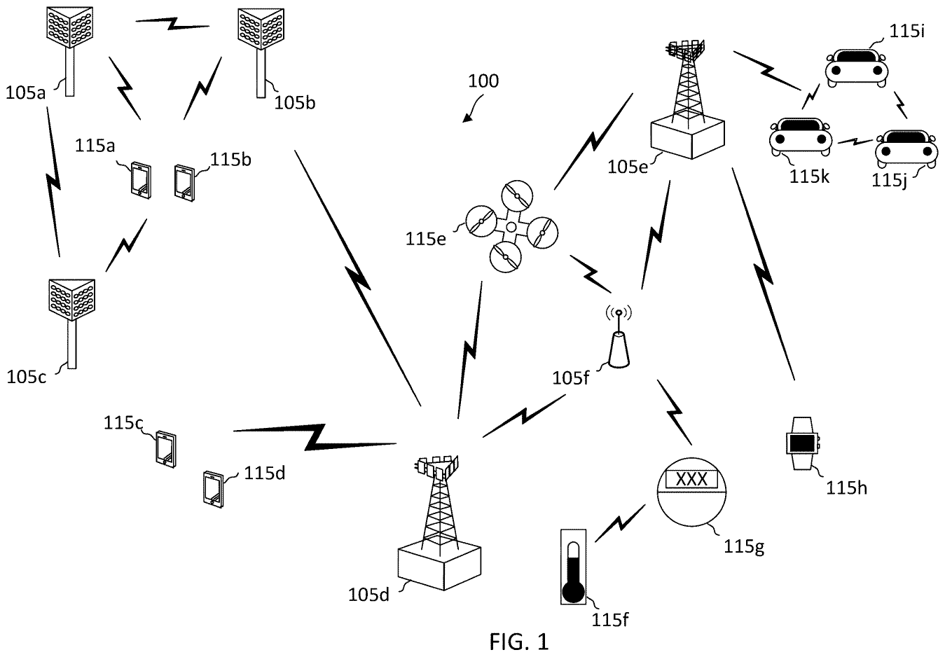

FIG. 1 illustrates a wireless communication network 100 according to one or more aspects of the present disclosure. The network 100 may be a 5G network. The network 100 includes a number of BSs 105 (individually labeled as 105a, 105b, 105c, 105d, 105e, and 105f) and other network entities. A BS 105 may be a station that communicates with UEs 115 (individually labeled as 115a, 115b, 115c, 115d, 115e, 115f, 115g, 115h, and 115k) and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

In some aspects, the term “base station” (e.g., the base station 105) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base stations 105. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are instances of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are instances of various machines configured for communication that access the network 100. The UEs 115i-115k are instances of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the DL and/or UL, desired transmission between BSs 105, backhaul transmissions between BSs, or sidelink transmissions between UEs 115.

In operation, the BSs 105 a-105c may serve the UEs 115 a and 115 b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an instance of a gNB or an access node controller (ANC)) may interface with the core network through backhaul links (e.g., NG-C, NG-U, etc.) and may perform radio configuration and scheduling for communication with the UEs 115. In various cases, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115 h (e.g., wearable device) may communicate through the network 100 either directly with BSs, such as the small cell BS 105f, and the macro BS 105e, or in multi-action-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some aspects, the subcarrier spacing between adjacent subcarriers may be fixed, and the total number of subcarriers (K) may be dependent on the system BW. The system BW may also be partitioned into subbands. In other aspects, the subcarrier spacing and/or the duration of TTIs may be scalable.

In some aspects, the BSs 105 can assign or schedule transmission resources (e.g., in the form of time-frequency resource blocks (RB)) for DL and UL transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for instance, about 10. Each slot may be further divided into mini-slots. In a FDD mode, simultaneous UL and DL transmissions may occur in different frequency bands. For instance, each subframe includes a UL subframe in a UL frequency band and a DL subframe in a DL frequency band. In a TDD mode, UL and DL transmissions occur at different time periods using the same frequency band. For instance, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For instance, each DL or UL subframe may have pre-defined regions for transmissions of reference signals, control information, and data. Reference signals are predetermined signals that facilitate the communications between the BSs 105 and the UEs 115. For instance, a reference signal can have a particular pilot pattern or structure, where pilot tones may span across an operational BW or frequency band, each positioned at a pre-defined time and a pre-defined frequency. For instance, a BS 105 may transmit cell specific reference signals (CRSs) and/or channel state information reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for DL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some aspects, the BSs 105 may broadcast the PSS, the SSS, and/or the MIB in the form of synchronization signal block (SSBs) and may broadcast the RMSI and/or the OSI over a physical downlink shared channel (PDSCH). The MIB may be transmitted over a physical broadcast channel (PBCH).

In some aspects, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI.

After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some instances, the random access procedure may be a four-step random access procedure. For instance, the UE 115 may transmit a random access preamble and the BS 105 may respond with a random access response. The random access response (RAR) may include a detected random access preamble identifier (ID) corresponding to the random access preamble, timing advance (TA) information, an UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some instances, the random access preamble, the RAR, the connection request, and the connection response can be referred to as message 1(MSG 1 ), message 2(MSG 2 ), message 3(MSG 3 ), and message 4(MSG 4 ), respectively. In some instances, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For instance, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant. The connection may be referred to as an RRC connection. When the UE 115 is actively exchanging data with the BS 105, the UE 115 is in an RRC connected state.

In some aspects, after establishing a connection with the BS 105, the UE 115 may initiate an initial network attachment procedure with the network 100. The BS 105 may coordinate with various network entities or fifth generation core (5GC) entities, such as an access and mobility function (AMF), a serving gateway (SGW), and/or a packet data network gateway (PGW), to complete the network attachment procedure. For instance, the BS 105 may coordinate with the network entities in the 5GC to identify the UE, authenticate the UE, and/or authorize the UE for sending and/or receiving data in the network 100. In addition, the AMF may assign the UE with a group of tracking areas (TAs). Once the network attach procedure succeeds, a context is established for the UE 115 in the AMF. After a successful attach to the network, the UE 115 can move around the current TA. For tracking area update (TAU), the BS 105 may request the UE 115 to update the network 100 with the UE 115's location periodically. Alternatively, the UE 115 may only report the UE 115's location to the network 100 when entering a new TA. The TAU allows the network 100 to quickly locate the UE 115 and page the UE 115 upon receiving an incoming data packet or call for the UE 115.

In some aspects, the BS 105 may communicate with a UE 115 using HARQ techniques to improve communication reliability, for instance, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). After receiving the DL data packet, the UE 115 may transmit a feedback message for the DL data packet to the BS 105. In some instances, the UE 115 may transmit the feedback on an acknowledgment resource. The feedback may be an acknowledgement (ACK) indicating that reception of the DL data packet by the UE 115 is successful (e.g., received the DL data without error) or may be a negative-acknowledgement (NACK) indicating that reception of the DL data packet by the UE 115 is unsuccessful (e.g., including an error or failing an error correction). In some aspects, if the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For instance, the BWP pair may include one BWP for UL communications and one BWP for DL communications.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

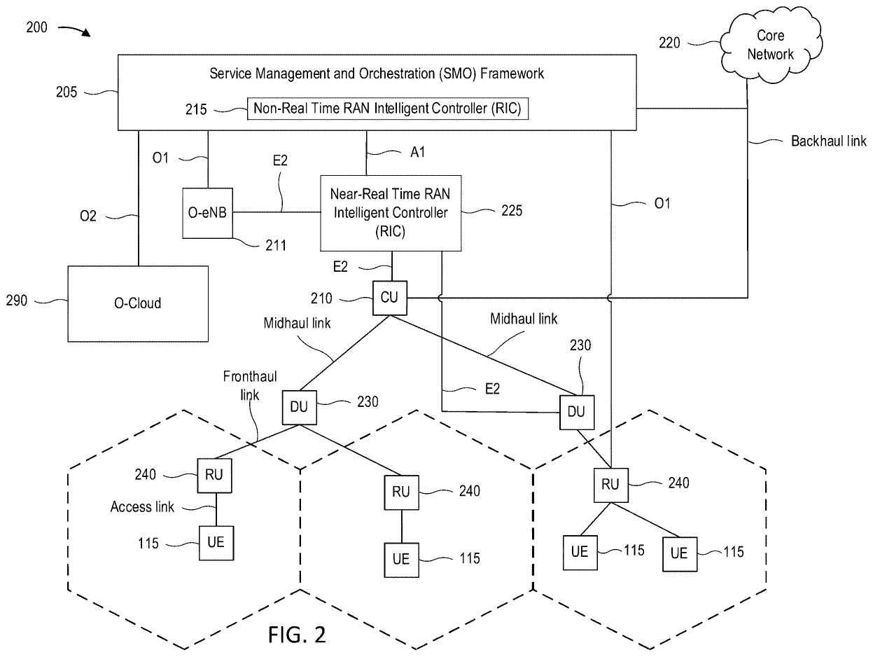

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 115 via one or more radio frequency (RF) access links. In some implementations, the UE 115 may be simultaneously served by multiple RUs 240.

Each of the units, i.e., the CUS 210, the DUs 230, the RUs 240, as well as the Near-RT RICs 225, the Non-RT RICs 215, and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

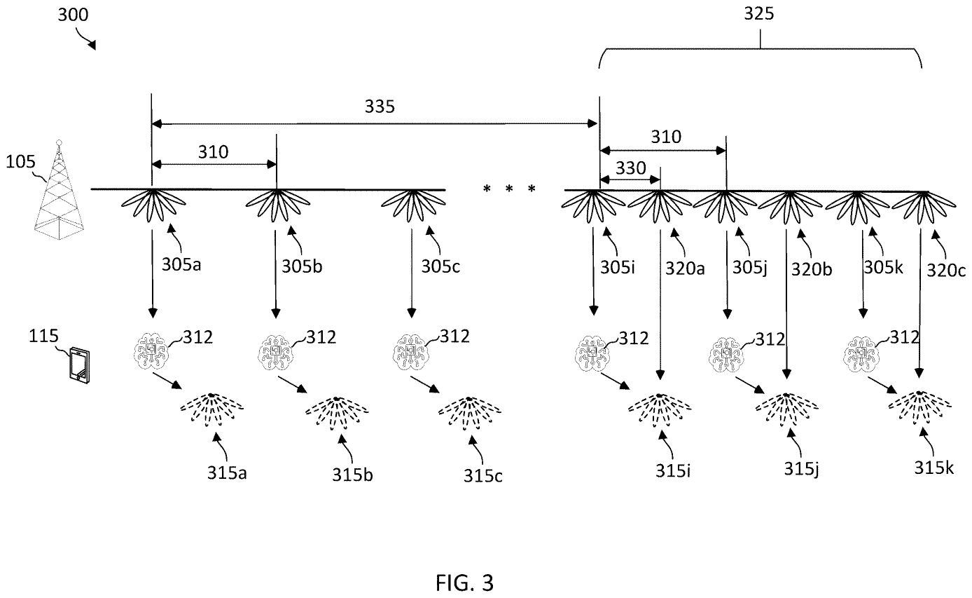

FIG. 3 illustrates a time domain beam prediction scheme 300 according to some aspects of the present disclosure. The time domain beam prediction scheme 300 illustrates aspects of predicting one or more beam characteristics using a machine learning (ML) model in accordance with the present disclosure. In this regard, aspects of the time domain beam prediction scheme 300 may be utilized in the context of the wireless communication network 100 as well as with other aspects of the present disclosure, including the spatial domain beam prediction schemes 400 and 500 and the ML model monitoring schemes 600 and 700.

As shown, a BS 105 may periodically transmit one or more reference signals (e.g., downlink reference signals, CSI-RS, CRS, SSB, etc.). In the illustrated example, the BS 105 transmits a nominal reference signal group 305a, 305b, 305c with a period 310 (e.g., 10 ms, 20 ms, 40 ms, or any other suitable period). In some aspects, the period 310 may be longer (e.g., twice the period, or otherwise) than a standard reference signal period, which can allow for power savings, reduced network congestion, and/or reduced interference by omitting one or more transmissions of reference signals relative to the standard reference signal period.

A UE 115 may utilize one or more ML models 312 to predict one or more beam parameters based on the reference signals received from the BS 105. Unless otherwise noted, it is understood that reference to a ML model in the present disclosure includes any type of program that relies on machine learning, including without limitation ML models, artificial intelligence (AI) models, AI/ML models, supervised learning models, unsupervised learning models, reinforcement learning models, semi-supervised learning models, self-supervised learning models, multi-instance learning models, inductive learning models, deductive inference models, transductive learning models, multi-task learning models, active learning models, online learning models, transfer learning models, ensemble learning models, and/or combinations thereof. Further, the ML model may include neural networks that are implemented at different types of nodes within a wireless communication network. For example, the neural networks may be implemented at a single node (e.g., UE/BS/central cloud server) or may be distributed over multiple nodes. The ML algorithms may be implemented to assist with different functions and/or modules among the nodes of the wireless communication network. In various aspects, the neural network may be implemented as a convolutional neural network (CNN), a recurrent neural network (RNN), a deep convolutional network (DCN), among others.

The UE 115 may utilize a ML model 312 to predict one or more beam parameters for a predicted beam group (e.g., predicted beam group 315a, 315b, or 315c) based on a nominal reference signal group (e.g., nominal reference signal group 305a, 305b, or 305c). In this regard, the ML model 312 executed by the UE 115 may utilize measurements and/or other information associated with the nominal reference signal group (e.g., 305a, 305b, or 305c) along with other pertinent parameters (e.g., UE mobility, UE location, etc.) and/or previously acquired data to determine one or more beam parameters (e.g., predicted beam measurements, predicted beam ranking order, etc.) for the predicted beam group (e.g., 315a, 315b, or 315c).

The predicted beam group may be associated with a future reference signal monitoring occasion (e.g., the reference signal monitoring occasions associated with nominal reference signal groups 305b or 305c) and/or between reference signal monitoring occasions. For example, FIG. 3 illustrates an instance where the predicted beam groups (e.g., predicted beam groups 315a and 315b) are associated with a time period between reference signal monitoring occasions (e.g., between the reference signal monitoring occasions associated with nominal reference signal groups 305a and 305b for predicted beam group 315a and between the reference signal monitoring occasions associated with nominal reference signal groups 305b and 305c for predicted beam group 315b). In some instances, the predicted beam groups are associated with time periods between reference signal monitoring occasions where reference signal transmissions are omitted but would occur if a standard reference signal periodicity was being used.

The BS 105 may periodically transmit one or more auxiliary reference signal groups 320a, 320b, 320c during a ML model evaluation period 325. In some instances, the auxiliary reference signal groups 320a, 320b, 320c are spaced from a nominal reference signal group 305i, 305j, 305k by a period 330 (e.g., 5 ms, 10 ms, 20 ms, or any other suitable period). In some aspects, the period 330 may be a standard reference signal period. For example, in some instances, the auxiliary reference signal groups 320a, 320b, 320c may be transmitted in standard reference signal transmission occasions that are omitted outside of the ML model evaluation period 325. Further, in some instances the ML model evaluation period 325 may occur periodically (e.g., based on period 335 (e.g., 100 ms, 500 ms, or other suitable period)) and/or ad hoc. In some instances, the BS 105 may indicate the timing of the ML model evaluation period 325 in a ML model monitoring configuration, radio resource control (RRC) message, and/or other suitable communication.

The auxiliary reference signal groups 320a, 320b, 320c may be utilized by the UE 115 to evaluate the performance of the ML model 312. For example, the UE 115 may utilize the ML model 312 to predict one or more beam parameters for a predicted beam group (e.g., predicted beam group 315i, 315j, or 315k) based on a nominal reference signal group (e.g., nominal reference signal group 305i, 305j, or 305k). Each predicted beam group (e.g., predicted beam group 315i, 315j, or 315k) may be associated with an auxiliary reference signal group (e.g., auxiliary reference signal group 320a, 320b, or 320c). In this regard, one or more measurements for the auxiliary reference signal group that the predicted beam group is associated with may be utilized to evaluate the performance of the ML model. For example, as discussed further below, measurement(s) for the auxiliary reference signal group may be compared to measurement(s) of predicted beams of the ML model 312 and/or compared to predicted measurement(s) of the predicted beams of the ML model 312 to evaluate the performance of the ML model 312. In this regard, the comparison may indicate that a ML model failure instance (MFI) has occurred. If a sufficient number of MFIs occurs within a period of time (e.g., based on a ML model failure detection (MFD) timer), then it may be an indication that the ML model 312 has failed. In this manner, the occurrence of one or more events (e.g., MFIs and/or model failures) associated with the ML model may be detected.

As discussed further below, in response to detecting an event, such as a failure of the ML model 312, the UE may stop the ML model 312, initiate retraining of the ML model 312, and/or transmit an indication of the failure of the ML model 312 to the BS 105. In some instances, the UE may determine the ML model 312 is operating properly and may continue running the ML model 312 and/or transmit an indication of proper operation of the ML model 312 to the BS 105.

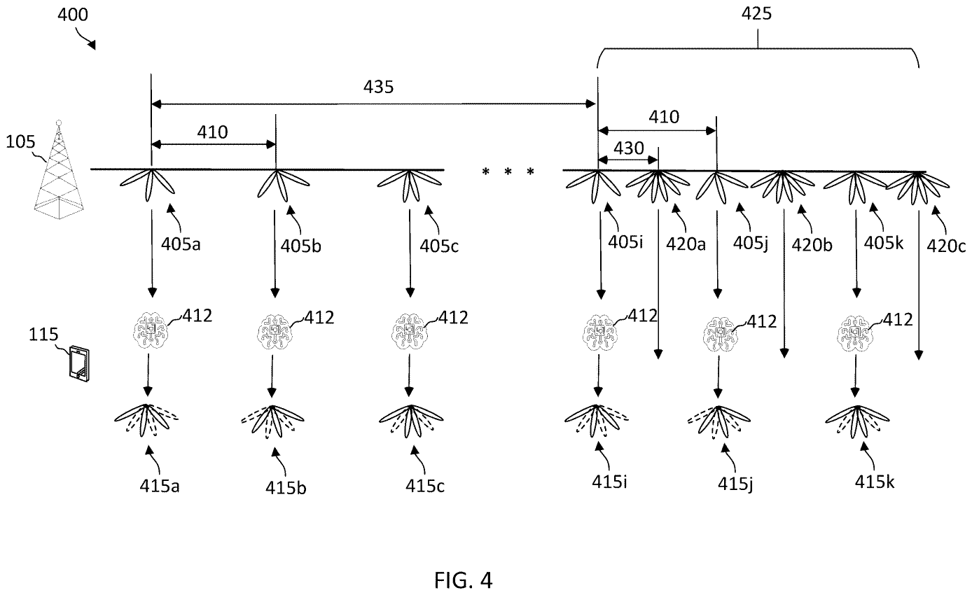

FIG. 4 illustrates a spatial domain beam prediction scheme 400 according to some aspects of the present disclosure. The spatial domain beam prediction scheme 400 illustrates aspects of predicting one or more beam characteristics using a machine learning (ML) model in accordance with the present disclosure. In this regard, aspects of the spatial domain beam prediction scheme 400 may be utilized in the context of the wireless communication network 100 as well as with other aspects of the present disclosure, including the time domain beam prediction scheme 300, the spatial domain beam prediction scheme 500, and the ML model monitoring schemes 600 and 700.

As shown, a BS 105 may periodically transmit one or more reference signals (e.g., downlink reference signals, CSI-RS, CRS, SSB, etc.). In the illustrated example, the BS 105 transmits a nominal reference signal group 405 a, 405 b, 405 c with a period 410 (e.g., 10 ms, 20 ms, 40 ms, or any other suitable period). In some aspects, the period 410 may be longer (e.g., twice the period, or otherwise) than a standard reference signal period, which can allow for power savings, reduced network congestion, and/or reduced interference by omitting one or more transmissions of reference signals relative to the standard reference signal period. As shown, for each nominal reference signal group 405a, 405b, and 405c the BS may transmit the reference signals using less than all of the available and/or active beam directions. In this regard, the beam direction(s) transmitted for each of nominal reference signal group 405a, 405b, and 405c may include the same and/or different beam directions than the other nominal reference signal groups 405a, 405b, and 405c.

A UE 115 may utilize one or more ML models 412 to predict one or more beam parameters based on the nominal reference signals received from the BS 105. The UE 115 may utilize a ML model 412 to predict one or more beam parameters for a predicted beam group (e.g., predicted beam group 415a, 415b, or 415c) based on a nominal reference signal group (e.g., nominal reference signal group 405a, 305b, or 305c). In this regard, the ML model 412 executed by the UE 115 may utilize measurements and/or other information associated with the nominal reference signal group (e.g., 405a, 405b, or 405c) along with other pertinent parameters (e.g., UE mobility, UE location, etc.) and/or previously acquired data to determine one or more beam parameters (e.g., predicted beam measurements, predicted beam ranking order, etc.) for the predicted beam group (e.g., 415a, 415b, or 415c). More specifically, the UE 115 may utilize the ML model 412 to estimate one or more beam parameters for the beam directions that were not transmitted as part of the reference signals of the corresponding nominal reference signal groups 405a, 405b, and 405c. In this regard, the solid lines in the predicted beam groups 415a, 415b, and 415c, the UE 115 represent the beam directions that were transmitted as part of the reference signals of the corresponding nominal reference signal groups 405a, 405b, and 405c, while the dashed lines represent the beam directions that were not transmitted by the corresponding nominal reference signal groups 405a, 405b, and 405c.

The BS 105 may periodically transmit one or more auxiliary reference signal groups 420a, 420b, 420c during a ML model evaluation period 425. In some instances, the auxiliary reference signal groups 420a, 420b, 420c are spaced from a nominal reference signal group 405i, 405j, 405k by a period 430 (e.g., 5 ms, 10 ms, 20 ms, or any other suitable period). In some aspects, the period 430 may be a standard reference signal period. For example, in some instances, the auxiliary reference signal groups 420a, 420b, 420c may be transmitted in standard reference signal transmission occasions that are omitted outside of the ML model evaluation period 425. Further, in some instances the ML model evaluation period 425 may occur periodically (e.g., based on period 435 (e.g., 100 ms, 500 ms, or other suitable period)) and/or ad hoc. In some instances, the BS 105 may indicate the timing of the ML model evaluation period 425 in a ML model monitoring configuration, radio resource control (RRC) message, and/or other suitable communication.

The auxiliary reference signal groups 420a, 420b, 420c may be utilized by the UE 115 to evaluate the performance of the ML model 412. In this regard, as shown the auxiliary reference signal groups 420a, 420b, 420c may transmit reference signals in all of the available and/or active beam directions, or at least more beam directions than the nominal reference signal groups 405i, 405j, 405k. One or more measurements of the auxiliary reference signal group may be utilized to evaluate the performance of the ML model 412 based on the predicted beam groups 415i, 415j, and 415k. For example, the UE 115 may utilize the ML model 412 to predict one or more beam parameters for beam directions not transmitted as part of a nominal reference signal group (e.g., nominal reference signal group 405i, 405j, or 405k) in generating the predicted beam groups 415i, 415j, and 415k. As discussed further below, measurement(s) for the auxiliary reference signal group may be compared to measurement(s) of predicted beams of the ML model 412 and/or compared to predicted measurement(s) of the predicted beams of the ML model 412 to evaluate the performance of the ML model 412. In this regard, the comparison may indicate that a ML model failure instance (MFI) has occurred. If a sufficient number of MFIs occurs within a period of time (e.g., based on a ML model failure detection (MFD) timer), then it may be an indication that the ML model 412 has failed. In this manner, the occurrence of one or more events (e.g., MFIs and/or model failures) associated with the ML model may be detected.

As discussed further below, in response to detecting an event, such as a failure of the ML model 412, the UE may stop the ML model 412, initiate retraining of the ML model 412, and/or transmit an indication of the failure of the ML model 412 to the BS 105. In some instances, the UE may determine the ML model 412 is operating properly and may continue running the ML model 412 and/or transmit an indication of proper operation of the ML model 412 to the BS 105.

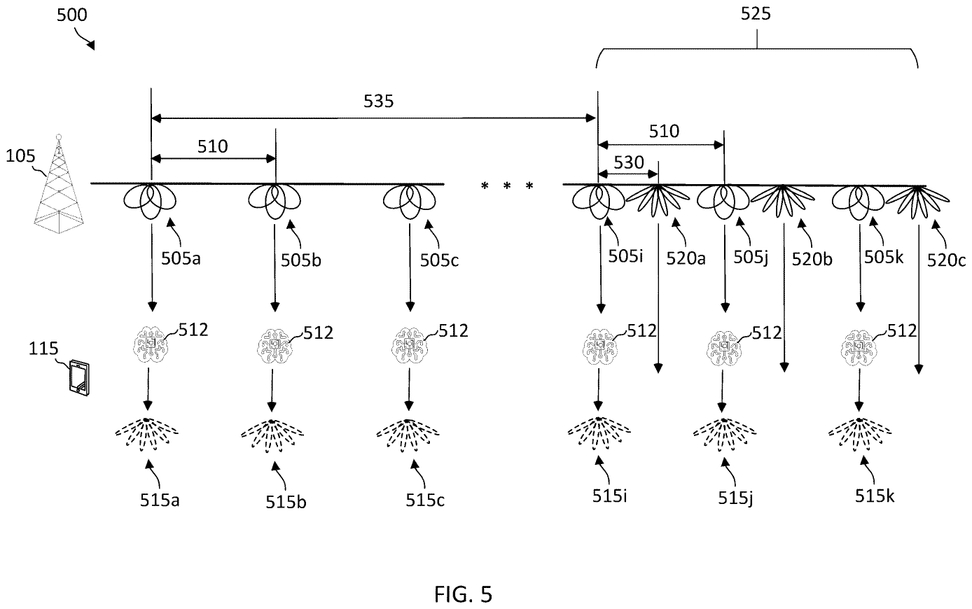

FIG. 5 illustrates a spatial domain beam prediction scheme 500 according to one or more aspects of the present disclosure. The spatial domain beam prediction scheme 500 illustrates aspects of predicting one or more beam characteristics using a machine learning (ML) model in accordance with the present disclosure. In this regard, aspects of the spatial domain beam prediction scheme 500 may be utilized in the context of the wireless communication network 100 as well as with other aspects of the present disclosure, including the time domain beam prediction scheme 300, the spatial domain beam prediction scheme 400, and the ML model monitoring schemes 600 and 700.

As shown, a BS 105 may periodically transmit one or more reference signals (e.g., downlink reference signals, CSI-RS, CRS, SSB, etc.). In the illustrated example, the BS 105 transmits a nominal reference signal group 505a, 505b, 505c with a period 510 (e.g., 10 ms, 20 ms, 40 ms, or any other suitable period). In some aspects, the period 510 may be longer (e.g., twice the period, or otherwise) than a standard reference signal period, which can allow for power savings, reduced network congestion, and/or reduced interference by omitting one or more transmissions of reference signals relative to the standard reference signal period. As shown, for each nominal reference signal group 505a, 505b, and 505c the BS using wideband beams. In this regard, the wideband beams transmitted for each of nominal reference signal group 505a, 505b, and 505c may include the same and/or different wideband beams as the other nominal reference signal groups 505a, 505b, and 505c

A UE 115 may utilize one or more ML models 512 to predict one or more beam parameters based on the nominal reference signals received from the BS 105. The UE 115 may utilize a ML model 512 to predict one or more beam parameters for a predicted beam group (e.g., predicted beam group 515a, 515b, or 515c) based on a nominal reference signal group (e.g., nominal reference signal group 505a, 505b, or 505c). In this regard, the ML model 512 executed by the UE 115 may utilize measurements and/or other information associated with the nominal reference signal group (e.g., 505a, 505b, or 505c) along with other pertinent parameters (e.g., UE mobility, UE location, etc.) and/or previously acquired data to determine one or more beam parameters (e.g., predicted beam measurements, predicted beam ranking order, etc.) for the predicted beam group (e.g., 515a, 515b, or 515c). More specifically, the UE 115 may utilize the ML model 512 to estimate one or more beam parameters for the narrowband beams that were not transmitted as part of the wideband reference signals of the corresponding nominal reference signal groups 505a, 505b, and 505c. In this regard, while FIG. 5 shows transmission of wideband reference signals and prediction of narrowband beams, in other aspects of the present disclosure narrowband reference signals may be transmitted and a ML model may be utilized to predict one or more beam parameters for wideband beams based on the narrowband reference signals.

The BS 105 may periodically transmit one or more auxiliary reference signal groups 520a, 520b, 520c during a ML model evaluation period 525. In some instances, the auxiliary reference signal groups 520a, 520b, 520c are spaced from a nominal reference signal group 505i, 505j, 505k by a period 530 (e.g., 5 ms, 10 ms, 20 ms, or any other suitable period). In some aspects, the period 530 may be a standard reference signal period. For example, in some instances, the auxiliary reference signal groups 520a, 520b, 520c may be transmitted in standard reference signal transmission occasions that are omitted outside of the ML model evaluation period 525. Further, in some instances the ML model evaluation period 525 may occur periodically (e.g., based on period 535 (e.g., 100 ms, 500 ms, or other suitable period)) and/or ad hoc. In some instances, the BS 105 may indicate the timing of the ML model evaluation period 525 in a ML model monitoring configuration, radio resource control (RRC) message, and/or other suitable communication.

The auxiliary reference signal groups 520a, 520b, 520c may be utilized by the UE 115 to evaluate the performance of the ML model 512. In this regard, as shown the auxiliary reference signal groups 520a, 520b, 520c may transmit narrowband reference signals in one or more of the available and/or active beam directions and/or in one or more of the beam directions predicted by ML model 512 for the predicted beam groups 515i, 515j, 515k based on the nominal reference signal groups 505i, 505j, 505k. In this regard, one or more measurements of the auxiliary reference signal group may be utilized to evaluate the performance of the ML model 512 based on the predicted beam groups 515i, 515j, and 515k. For example, the UE 115 may utilize the ML model 512 to predict one or more beam parameters for the narrowband beam directions not transmitted as part of a nominal reference signal group (e.g., nominal reference signal group 505i, 505j, or 505k) in generating the predicted beam groups 515i, 515j, and 515k. As discussed further below, measurement(s) for the auxiliary reference signal group may be compared to measurement(s) of predicted beams of the ML model 512 and/or compared to predicted measurement(s) of the predicted beams of the ML model 512 to evaluate the performance of the ML model 512. In this regard, the comparison may indicate that a ML model failure instance (MFI) has occurred. If a sufficient number of MFIs occurs within a period of time (e.g., based on a ML model failure detection (MFD) timer), then it may be an indication that the ML model 412 has failed. In this manner, the occurrence of one or more events (e.g., MFIs and/or model failures) associated with the ML model may be detected.

As discussed further below, in response to detecting an event, such as a failure of the ML model 512, the UE may stop the ML model 512, initiate retraining of the ML model 512, and/or transmit an indication of the failure of the ML model 512 to the BS 105. In some instances, the UE may determine the ML model 512 is operating properly and may continue running the ML model 512 and/or transmit an indication of proper operation of the ML model 512 to the BS 105.

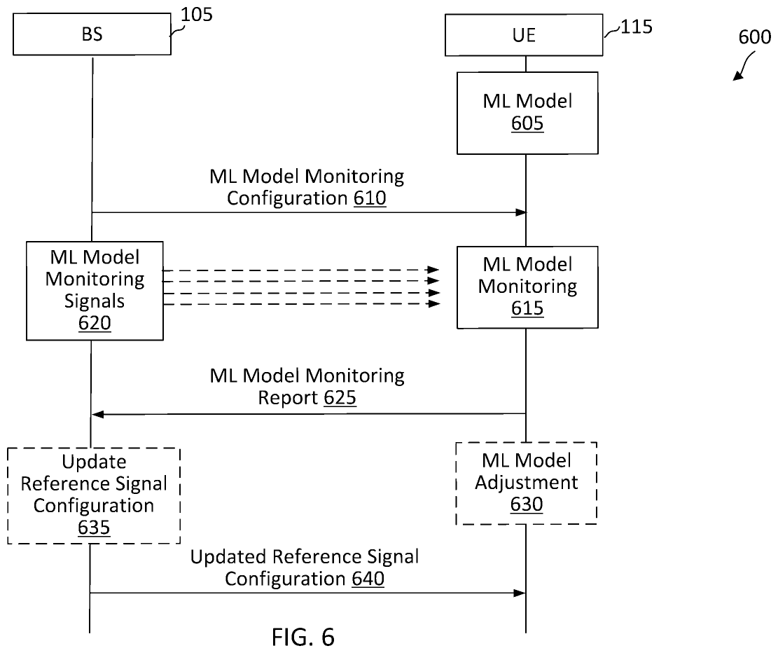

FIG. 6 illustrates a signaling diagram for a machine learning (ML) model monitoring scheme 600 according to one or more aspects of the present disclosure. The ML model monitoring scheme 600 illustrates aspects of monitoring the performance of a ML model in accordance with the present disclosure. In this regard, aspects of the ML model monitoring scheme 600 may be utilized in the context of the wireless communication network 100 as well as with other aspects of the present disclosure, including the time domain beam prediction scheme 300, the spatial domain beam prediction schemes 400 and 500, and the ML model monitoring scheme 700.

At action 605, a UE 115 runs a ML model. The ML model run by the UE may include any type of program that relies on machine learning, including without limitation ML models, artificial intelligence (AI) models, AI/ML models, supervised learning models, unsupervised learning models, reinforcement learning models, semi-supervised learning models, self-supervised learning models, multi-instance learning models, inductive learning models, deductive inference models, transductive learning models, multi-task learning models, active learning models, online learning models, transfer learning models, ensemble learning models, and/or combinations thereof. Further, the ML model may include neural networks that are implemented at different types of nodes within a wireless communication network. For example, the neural networks may be implemented at a single node (e.g., UE/BS/central cloud server) or may be distributed over multiple nodes. The ML algorithms may be implemented to assist with different functions and/or modules among the nodes of the wireless communication network. In various aspects, the neural network may be implemented as a convolutional neural network (CNN), a recurrent neural network (RNN), a deep convolutional network (DCN), among others.

In some aspects of the present disclosure, the ML model is configured to predict one or more beam parameters, including without limitation predicted beam measurements (e.g., RSRP (e.g., L1-RSRP), RSRQ, RSSI, SINR, etc.), predicted beam ranking order, narrowband beams, wideband beams, etc. In some instances, the ML model(s) may include an ML model utilized by the UE for beam prediction. For example, the ML model may be configured to provide a time domain beam prediction (e.g., as discussed with respect to FIG. 3) and/or a spatial domain beam prediction (e.g., as discussed with respect to FIGS. 4 and 5). In some instances, the UE 115 may run multiple ML models. The multiple ML models may perform similar and/or different functions.

At action 610, a BS 105 transmits a ML model monitoring configuration to the UE 115. In some instances, the action 610 occurs before the action 605. That is, in some instances the UE 115 may receive the ML model monitoring configuration before starting the ML model. In other instances, the UE 115 may start the ML model before receiving the ML model monitoring configuration. In some aspects, the UE 115 may receive an initial ML model monitoring configuration and subsequently receive an updated ML model monitoring configuration. In this regard the BS 105 may update one or more parameters of the ML model monitoring configuration and transmit an updated ML model monitoring configuration and/or an indication of the updated parameter(s).

The UE may receive the ML model monitoring configuration and/or any updates to the ML model monitoring configuration from the network unit via a radio resource control (RRC) message or other suitable communication. In some aspects, the ML model monitoring configuration may be included as an information element of the communication. The ML model monitoring configuration may include one or more parameters associated with ML model monitoring and/or reporting. For example, the ML model monitoring configuration may include an indication of one or more of a ML model failure detection (MFD) timer duration, a maximum number of ML model failure instances (MFIs), one or more values associated with one or more MFI criterion, and/or other parameters associated with ML model monitoring and/or reporting. That is, the ML model monitoring configuration may include an indication of one or more parameters and/or criterion utilized to detect the occurrence of one or more events associated with the ML model. The UE may utilize information from the ML model monitoring configuration to evaluate the performance of one or more ML models.

At action 615, the UE 115 performs ML model monitoring based on the ML model monitoring configuration. In some instances, the UE 115 performs the ML model monitoring based on one or more ML monitoring signals transmitted by the BS 105 at action 620. The ML monitoring signals may include one or more reference signals, such as downlink reference signals, CSI-RS, CRS, SSB, etc. In some instances, the BS 105 may periodically transmit the nominal reference signals and/or auxiliary reference signals as described above with respect to FIGS. 3-5.

In some instances, at action 615, the UE evaluates one or more values associated with a prediction of the ML model to one or more measured values. In some aspects, the UE evaluates the value(s) associated with the prediction of the ML model to the measured value(s) based at least in part on the ML model monitoring configuration received at action 610. In this regard, the UE may utilize information from the ML model monitoring configuration to evaluate the performance of the ML model. For example, the UE may evaluate the one or more values associated with the prediction of the ML model based on an indication of a ML model failure detection (MFD) timer duration, an indication of a maximum number of ML model failure instances (MFIs), an indication of one or more values associated with one or more MFI criterion, and/or the other parameters indicated in the ML model monitoring configuration.

In some aspects, the UE may detect, based on the evaluation, one or more events, such as one or more ML model failure instance(s) (MFIs) and/or the failure of the ML model. In this manner, the UE may detect the event(s) (MFIs and/or the failure of the ML model) based on the ML model monitoring configuration. In some instances, the UE detects an initial MFI based on information from the ML model monitoring configuration. In this regard, the UE may determine whether an MFI criterion is satisfied for each of a plurality of monitoring occasions. In some aspects, the UE determines whether the MFI criterion is satisfied by evaluating the one or more value(s) associated with the prediction of the ML model relative to the one or more measured value(s).

In some instances, at action 615, the UE evaluates one or more measured values associated with the prediction of the ML model to one or more measured values associated with a group of measured beams. In some instances, the UE may determine whether a top-1 predicted beam of the ML model is included in a set of top-K beams of the group of measured beams. For example, referring back to FIG. 3, the UE may determine whether a measurement (e.g., RSRP (e.g., L1-RSRP), RSRQ, RSSI, SINR, etc.) associated with the top-1 predicted beam of the predicted beam group 315i is within the top-K beams (e.g., top 1, 2, 3, 4, 5, etc. beams) of the group of measured beams of auxiliary reference signal group 320a. In this regard, the measurement associated with the top-1 predicted beam of the predicted beam group 315i may be a measurement of the corresponding beam of the group of measured beams of auxiliary reference signal group 320a. For example, if ML model predicts that a particular beam (e.g., beam index 2) is the top-1 predicted beam, then the measurement of that particular beam (e.g., beam index 2) from the group of measured beams of auxiliary reference signal group 320a may be used as the measurement associated with the top-1 predicted beam of the predicted beam group 315i.

In some instances, the MFI criterion may be satisfied if the top-1 predicted beam of the ML model is not included in the set of top-K beams of the group of measured beams. That is, an MFI is present if the top-1 predicted beam of the ML model is not included in the set of top-K beams of the group of measured beams. For example, if the measurement associated with the top-1 predicted beam (e.g., beam index 2) of the ML model is not included in the top-K (e.g., 1, 2, 3, 4, etc.) beams of the group of measured beams of auxiliary reference signal group 320a, then an MFI is present. On the other hand, if the top-1 predicted beam of the ML model is included in the set of top-K beams of the group of measured beams, then the ML model may be considered to be operating appropriately and an MFI is not present. For example, if the measurement associated with the top-1 predicted beam (e.g., beam index 2) of the ML model is included in the top-K (e.g., 1, 2, 3, 4, etc.) beams of the group of measured beams of auxiliary reference signal group 320a, then an MFI is not present.

In some instances, the UE may determine whether a top-1 measured beam of the group of measured beams is included in a set of top-K beams of a group of predicted beams associated with the prediction of the ML model. For example, referring back to FIG. 3, the UE may determine whether a top-1 measured beam from the group of measured beams of auxiliary reference signal group 320 a is in the top-K beams (e.g., top 1, 2, 3, 4, 5, etc. beams) of the predicted beam group 315i. The determination of the ranking of the beams may be based on RSRP (e.g., L1-RSRP), RSRQ, RSSI, SINR, etc. In this regard, the measurement of the top-1 measured beam from the group of measured beams of auxiliary reference signal group 320a may be based on the measurements of the beams in the group of measured beams of auxiliary reference signal group 320a. The measurements associated with the top-K predicted beams of the predicted beam group 315i may be measurements of the corresponding beams of the group of measured beams of auxiliary reference signal group 320a. For example, if ML model predicts that particular beams (e.g., beam indexes 2, 3, and 4) are the top-3 predicted beams, then the measurements of those particular beams (e.g., beam indexes 2, 3, and 4) from the group of measured beams of auxiliary reference signal group 320a may be used as the measurements associated with the top-K predicted beams of the predicted beam group 315i.

In some instances, the MFI criterion maybe satisfied if the top-1 measured beam of the group of measured beams is not included in the set of top-K beams of the group of predicted beams associated with the prediction of the ML model. That is, an MFI is present if the top-1 measured beam of the ML model is not included in the set of top-K beams of the group of the predicted beams of the ML model. For example, if the measurement associated with the top-1 measured beam (e.g., beam index 2) of the group of measured beams of auxiliary reference signal group 320a is not included in the top-K (e.g., 1, 2, 3, 4, etc.) beams of the predicted beam group 315i, then an MFI is present. On the other hand, if the top-1 measured beam of the group of measured beams of auxiliary reference signal group 320a is included in the set of top-K beams of the predicted beam group 315i, then the ML model may be considered to be operating appropriately and an MFI is not present. For example, if the measurement associated with the top-1 measured beam (e.g., beam index 2) of the group of measured beams of auxiliary reference signal group 320a is included in the top-K (e.g., 1, 2, 3, 4, etc.) beams of the predicted beam group 315 i, then an MFI is not present.

In some instances, the UE may determine whether a layer 1 reference signal receive power (L1-RSRP) and/or other measurement(s) (e.g., RSRQ, RSSI, SNIR, etc.) of a top-1 predicted beam of the ML model is within a threshold difference of an L1-RSRP of a top-1 measured beam of the group of measured beams. For example, referring back to FIG. 3, the UE may determine whether the L1-RSRP associated with the top-1 predicted beam of the predicted beam group 315i is within a threshold difference of a measured L1-RSRP of the top-1 beam of the group of measured beams of of auxiliary reference signal group 320a. In this regard, the L1-RSRP associated with the top-1 predicted beam of the predicted beam group 315i may be a measurement of the corresponding beam of the group of measured beams of auxiliary reference signal group 320a. For example, if ML model predicts that a particular beam (e.g., beam index 2) is the top-1 predicted beam, then the measurement of that particular beam (e.g., beam index 2) from the group of measured beams of auxiliary reference signal group 320a may be used as the measurement associated with the top-1 predicted beam of the predicted beam group 315i.

In some instances, the MFI criterion is satisfied if the L1-RSRP and/or other measurement(s) of the top-1 predicted beam of the ML model (e.g., beam index 2) is not within the threshold difference (e.g., 0.5 dB, 1.0 dB, 1.5 dB, or otherwise) of the L 1-RSRP of the top-1 measured beam of the group of measured beams. On the other hand, if the L1-RSRP of the top-1 predicted beam of the ML model is within the threshold difference of the L1-RSRP of the top-1 beam of the group of measured beams, then the ML model may be considered to be operating appropriately and an MFI is not present. In some instances, the UE may receive an indication of the threshold difference from the network unit. In some aspects, the indication of the threshold difference may be included in the ML model monitoring configuration.

In some instances, the UE evaluates one or more predicted values associated with a prediction of the ML model to one or more measured values associated with a group of measured beams. In some instances, the UE determines whether a predicted layer 1 reference signal receive power (L1-RSRP) and/or other measurement(s) (e.g., RSRQ, RSSI, SNIR, etc.) of a top-1 predicted beam of the ML model is within a threshold difference of a measured L1-RSRP of a top-1 measured beam of the group of measured beams. For example, referring back to FIG. 3, the UE may determine whether a predicted L1-RSRP associated with the top-1 predicted beam of the predicted beam group 315i is within a threshold difference of a measured L1-RSRP of the top-1 beam of the group of measured beams of auxiliary reference signal group 320a. In this regard, the L1-RSRP associated with the top-1 predicted beam of the predicted beam group 315i may be a measurement of the corresponding beam of the group of measured beams of auxiliary reference signal group 320a.

In some aspects, the MFI criterion is satisfied if the predicted L1-RSRP of the top-1 predicted beam (e.g., beam index 2) of the ML model is not within the threshold difference (e.g., 0.5 dB, 1.0 dB, 1.5 dB, or otherwise) of the measured L1-RSRP of the top-1 measured beam of the group of measured beams. On the other hand, if the predicted L1-RSRP of the top-1 predicted beam of the ML model is within the threshold difference of the measured L1-RSRP of the top-1 beam of the group of measured beams, then the ML model may be considered to be operating appropriately and an MFI is not present. In some instances, the UE may receive an indication of the threshold difference between the predicted L1-RSRP and the measured L1-RSRP from the network unit. In some aspects, the indication of the threshold difference between the predicted L1-RSRP and the measured L1-RSRP may be included in the ML model monitoring configuration.

In response to detecting an initial MFI (e.g., based on one or more of the criteria discussed above), the UE may start a ML model failure detection (MFD) timer as part of action 615. In some aspects, the ML model monitoring configuration includes an indication of a duration of the MFD timer. In some aspects, the UE determines that the ML model has failed based on detecting a number of MFIs before the end of the MFD timer. For example, if the UE detects a number of MFIs (e.g., based on one or more of the criteria discussed above) before the expiration of the MFD timer that exceeds a threshold, then the UE may determine the ML model has failed. In this regard, the UE may increment an MFI counter for the initial MFI and/or each of the number of MFIs before the end of the MFD timer. If the MFI counter reaches the threshold, then the UE may determine and/or declare that the ML model has failed. In some instances, the ML model monitoring configuration includes an indication of the threshold (e.g., 2, 3, 4, 5, 6, 7, etc.) number of MFIs associated with a ML model failure.

At action 625, the UE transmits a ML model monitoring report. The ML model monitoring report may indicate that the ML model is operating properly, has failed, and/or include one or more operating parameters associated with the ML model (e.g., number of MFIs detected in one or more ML model evaluation periods (e.g., 335, 435, 535)). For example, in response to detecting a failure of the ML model at action 615, the UE may transmit an indication of the failure of the ML model at action 625. The UE may transmit the indication of the failure of the ML model to the BS 105 via an RRC message, a PUCCH communication, a PUSCH communication, and/or other suitable communication.

At action 630, the UE may adjust an operation of the ML model. For example, in some instances the UE 115 receives an instruction to deactivate the ML model, retrain the ML model, and/or adjust one or more operating parameters of the ML model from the BS 105 in response to the UE 115 transmitting an indication of a failure of the ML model to the BS 105. Upon receiving the instruction to deactivate the ML model, retrain the ML model, and/or adjust one or more operating parameters of the ML model, the UE adjusts an operation of the ML model (e.g., stopping, retraining, and/or adjusting one or more operating parameters) based on the instruction received from the BS 105. In some instances, at action 630 the UE deactivates the ML model, initiates a retraining of the ML model, and/or adjusts one or more operating parameters of the ML model based on detecting a failure of the ML model at action 615.

At action 635, in some aspects the BS 105 may update a reference signal configuration based on the ML model monitoring report received at action 625. In some instances, if the ML model monitoring report notifies the BS 105 of a failure of the ML model, the BS 105 may update the reference signal configuration for the UE. For example, if the BS 105 was sending a down-sampled set of reference signals (e.g., less than all reference signal beam directions and/or less than all standard reference signal transmission occasions) and relied on the beam prediction capability of the ML model of the UE 115 at some beam management stages, then the BS 105 may update the reference signal configuration for the UE 115 to transmit more reference signals (e.g., more reference signal beam directions and/or more reference signal transmission occasions, up to and including all reference signal beam directions and/or all standard reference signal transmission occasions). At action 640, the BS 105 may transmit the updated reference signal configuration to the UE 115. The UE 115 may then utilize the updated reference signal configuration to monitor for reference signals from the BS 105.

In some instances, the UE may not detect a failure of the ML model at action 615. That is, the UE may determine, based on the ML model monitoring at action 615, that the ML model is operating appropriately. In some aspects, the UE may transmit an indication that the ML model is operating properly as part of the ML model monitoring report transmitted to the BS 105. For example, the UE may transmit the indication of the ML model working properly to a network unit via an RRC message, a PUCCH communication, a PUSCH communication, and/or other suitable communication. At action 630, the UE may continue operating the ML model as is if the ML model is determined to be performing adequately at action 615. In some aspects, even if the ML model is determined to be performing adequately at action 615, the UE may adjust one or more operating parameters of the ML model at action 630 in an effort to optimize the accuracy and/or benefits of the ML model.

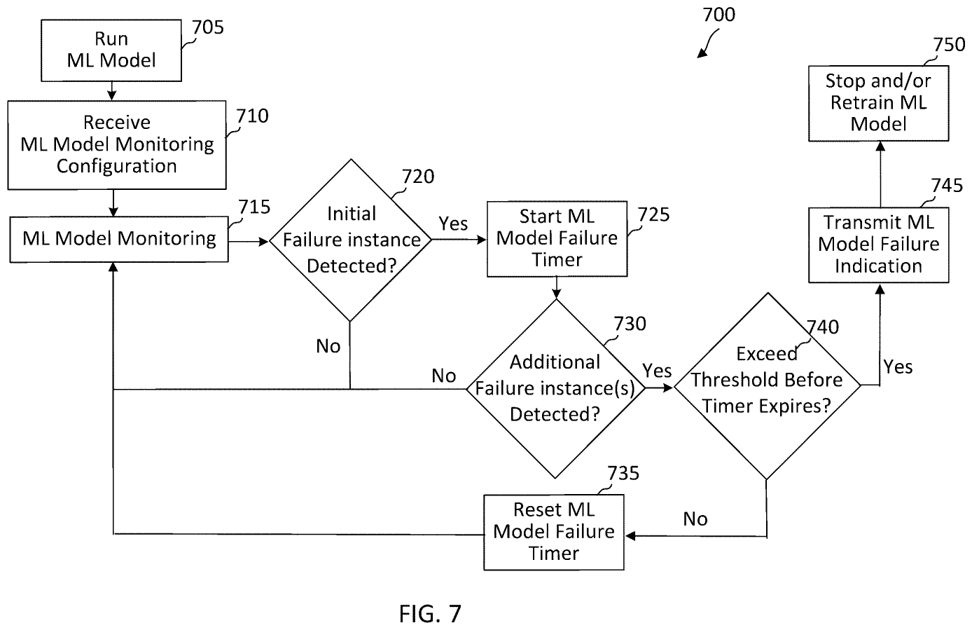

FIG. 7 illustrates a flow chart of a ML model monitoring scheme according to one or more aspects of the present disclosure. The ML model monitoring scheme 700 illustrates aspects of a user equipment (UE) monitoring the performance of a ML model in accordance with the present disclosure. In this regard, aspects of the ML model monitoring scheme 700 may be utilized in the context of the wireless communication network 100 as well as with other aspects of the present disclosure, including the time domain beam prediction scheme 300, the spatial domain beam prediction schemes 400 and 500, and the ML model monitoring scheme 600. Because aspects of ML model monitoring scheme 700 may be similar to those discussed above with respect to ML model monitoring scheme 600 and below with respect to the method 1000, some details are omitted in the following description. Please see the descriptions regarding the ML model monitoring scheme 600 and below with respect to the method 1000 (or other aspects of the present disclosure) for the additional details.

At action 705, a UE (e.g., UE 115 or UE 800) runs a ML model. The ML model may be configured to predict one or more beam parameters, including without limitation predicted beam measurements (e.g., RSRP (e.g., L1-RSRP), RSRQ, RSSI, SINR, etc.), predicted beam ranking order, narrowband beams, wideband beams, etc. In some instances, the ML model(s) may include an ML model utilized by the UE for beam prediction. For example, the ML model may be configured to provide a time domain beam prediction (e.g., as discussed with respect to FIG. 3) and/or a spatial domain beam prediction (e.g., as discussed with respect to FIGS. 4 and 5). In some instances, the UE 115 may run multiple ML models. The multiple ML models may perform similar and/or different functions.

At action 710, the UE receives a ML model monitoring configuration from a network unit. The ML model monitoring configuration may include one or more parameters associated with ML model monitoring and/or reporting. For example, the ML model monitoring configuration may include an indication of one or more of a ML model failure detection (MFD) timer duration, a maximum number of ML model failure instances (MFIs), one or more values associated with one or more MFI criterion, and/or other parameters associated with ML model monitoring and/or reporting. The UE may utilize information from the ML model monitoring configuration to evaluate the performance of one or more ML models.

At action 715, the UE 115 performs ML model monitoring based on the ML model monitoring configuration. In some instances, the UE 115 performs the ML model monitoring based on one or more ML monitoring signals transmitted by a network unit. The ML monitoring signals may include one or more reference signals, such as downlink reference signals, CSI-RS, CRS, SSB, etc.

At action 720, the UE determines whether an initial ML model failure instance (MFI) is detected. In some instances, the UE determines whether an MFI has occurred based on an evaluation of one or more values associated with a prediction of the ML model to one or more measured values. The UE may make this determination for one or more monitoring occasions during a ML model monitoring period. If the UE determines, at action 720, that an initial MFI has not been detected then the scheme 700 returns to action 715, where the UE continues the ML model monitoring.

If, at action 720, the UE determines that an initial MFI has been detected then the scheme 700 continues to action 725 where the UE starts an ML model failure detection (MFD) timer. In some instances, a length of the MFD timer may be indicated in the ML model monitoring configuration received at action 710. While the MFD timer is running, the UE determines, at action 730, whether additional MFIs are detected. If, at action 730, no additional MFIs are detected, then the scheme 700 returns to action 715, where the UE continues the ML model monitoring.

If, at action 730, the UE detects additional MFIs, then the scheme 700 continues to action 740 where the UE determines whether the number of detected MFIs exceeds a threshold. The value of the threshold may be preconfigured and/or indicated the ML model monitoring configuration received at action 710. If, at action 740, the number of MFIs detected is less than the threshold (or equal to the threshold in some instances), then the scheme 700 continues to action 735 where the MFD timer is reset. After resetting the MFD timer at action 735, the scheme 700 then returns to action 715, where the UE continues the ML model monitoring. If, at action 740, the number of MFIs detected is equal to or greater than the threshold (or just greater than the threshold in some instances), then the scheme 700 continues to action 745 where the UE transmits an indication of the ML model failure to the network unit.

At action 750, the UE may stop and/or retrain the ML model. In some instances, the UE may stop the ML model and/or initiate a retraining of the ML model automatically in response to detecting the failure of the ML model. In other instances, the UE may rely on an instruction from the network unit to determine whether to stop and/or retrain the ML model.

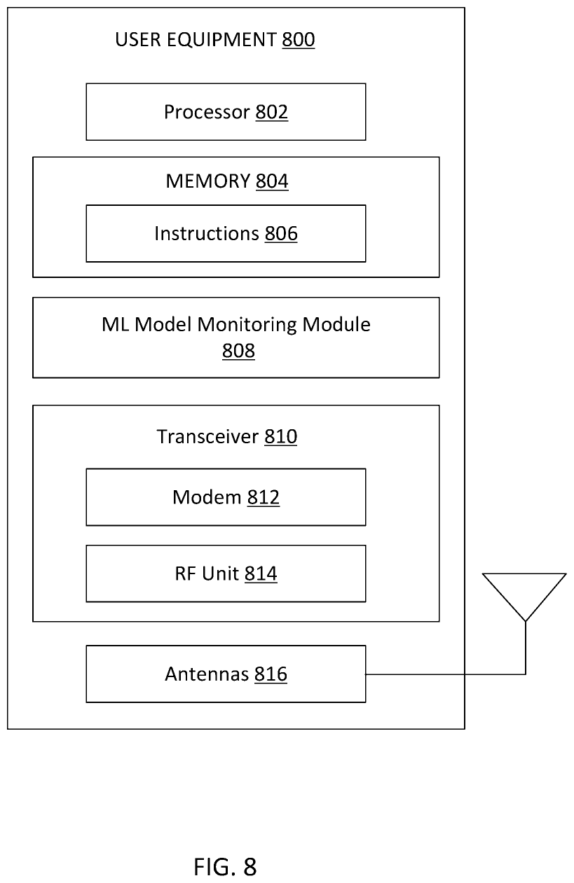

FIG. 8 is a block diagram of a UE 800 according to one or more aspects of the present disclosure. The UE 800 may be, for instance, a UE 115 as discussed in FIGS. 1-7. As shown, the UE 800 may include a processor 802, a memory 804, a machine learning (ML) model monitoring module 808, a transceiver 810 including a modem subsystem 812 and an RF unit 814, and one or more antennas 816. These elements may be coupled with one another. The term “coupled” may refer to directly or indirectly coupled or connected to one or more intervening elements. For instance, these elements may be in direct or indirect communication with each other, for instance via one or more buses.

The processor 802 may include a CPU, a DSP, an ASIC, a controller, a FPGA device, another hardware device, a firmware device, or any combination thereof configured to perform the operations described herein. The processor 802 may also be implemented as a combination of computing devices, e.g., a combination of a DSP and a microprocessor, a plurality of microprocessors, one or more microprocessors in conjunction with a DSP core, or any other such configuration.

The memory 804 may include a cache memory (e.g., a cache memory of the processor 802), RAM, MRAM, ROM, PROM, EPROM, EEPROM, flash memory, solid state memory device, hard disk drives, other forms of volatile and non-volatile memory, or a combination of different types of memory. In an aspect, the memory 804 includes a non-transitory computer-readable medium. The memory 804 may store, or have recorded thereon, instructions 806. The instructions 806 may include instructions that, when executed by the processor 802, cause the processor 802 to perform the operations described herein with reference to a UE 115 in connection with aspects of the present disclosure, for instance, aspects of FIGS. 3-7 and 10. Instructions 806 may also be referred to as program code. The program code may be for causing a wireless communication device to perform these operations, for instance by causing one or more processors (such as processor 802) to control or command the UE 800 to do so. The terms “instructions” and “code” should be interpreted broadly to include any type of computer-readable statement(s). For instance, the terms “instructions” and “code” may refer to one or more programs, routines, sub-routines, functions, procedures, etc. “Instructions” and “code” may include a single computer-readable statement or many computer-readable statements.

The ML model monitoring module 808 may be implemented via hardware, software, or combinations thereof. For instance, the ML model monitoring module 808 may be implemented as a processor, circuit, and/or instructions 806 stored in the memory 804 and executed by the processor 802. In some aspects, the ML model monitoring module 808 can be integrated within the modem subsystem 812. For instance, the ML model monitoring module 808 can be implemented by a combination of software components (e.g., executed by a DSP or a general processor) and hardware components (e.g., logic gates and circuitry) within the modem subsystem 812. The ML model monitoring module 808 may communicate with one or more components of the UE 800 to implement various aspects of the present disclosure, for instance, aspects of FIGS. 3-7 and 10.

In some aspects, the ML model monitoring module 808 may be configured, along with other components of the UE 800, to receive a machine learning (ML) model monitoring configuration. In some aspects, the ML model monitoring module 808 may be configured, along with other components of the UE 800, to evaluate one or more values associated with a prediction of a ML model to one or more measured values based at least in part on the ML model monitoring configuration. In some aspects, the ML model monitoring module 808 may be configured, along with other components of the UE 800, to transmit, in response to detecting a failure of the ML model (e.g., based on the evaluating), an indication of the failure of the ML model. In some aspects, the ML model monitoring module 808 may be configured, along with other components of the UE 800, to detect the failure of the ML model based on the ML model monitoring configuration. In some aspects, the ML model monitoring module 808 may be configured, along with other components of the UE 800, to deactivate the ML model based on detecting the failure of the ML model and/or receiving an instruction from a network unit to deactivate the ML model. In some aspects, the ML model monitoring module 808 may be configured, along with other components of the UE 800, to initiate retraining of the ML model based on detecting the failure of the ML model and/or receiving an instruction from a network unit to retrain the ML model.

In some aspects, the ML model monitoring module 808 is further configured to run one or more ML models. In this regard, the ML model monitoring module 808 may be configured, along with other components of the UE 800, to execute any type of program that relies on machine learning, including without limitation ML models, artificial intelligence (AI) models, AI/ML models, supervised learning models, unsupervised learning models, reinforcement learning models, semi-supervised learning models, self-supervised learning models, multi-instance learning models, inductive learning models, deductive inference models, transductive learning models, multi-task learning models, active learning models, online learning models, transfer learning models, ensemble learning models, and/or combinations thereof. Further, the ML model may include neural networks that are implemented at different types of nodes within a wireless communication network. For example, the neural networks may be implemented at a single node (e.g., UE/BS/central cloud server) or may be distributed over multiple nodes. The ML algorithms may be implemented to assist with different functions and/or modules among the nodes of the wireless communication network. In various aspects, the neural network may be implemented as a convolutional neural network (CNN), a recurrent neural network (RNN), a deep convolutional network (DCN), among others.

As shown, the transceiver 810 may include the modem subsystem 812 and the RF unit 814. The transceiver 810 can be configured to communicate bi-directionally with other devices, such as the BSs 105 and/or network units. The modem subsystem 812 may be configured to modulate and/or encode the data from the memory 804 and/or the ML model monitoring module 808 according to a MCS, e.g., a LDPC coding scheme, a turbo coding scheme, a convolutional coding scheme, a digital beamforming scheme, etc. The RF unit 814 may be configured to process (e.g., perform analog to digital conversion or digital to analog conversion, etc.) modulated/encoded data (e.g., communication signals, data signals, control signals, capability reports, ML model monitoring reports, ML model failure indications, etc.) from the modem subsystem 812 (on outbound transmissions). The RF unit 814 may be further configured to perform analog beamforming in conjunction with the digital beamforming. Although shown as integrated together in transceiver 810, the modem subsystem 812 and the RF unit 814 may be separate devices that are coupled together at the UE 800 to enable the UE 800 to communicate with other devices.

The RF unit 814 may provide the modulated and/or processed data, e.g., data packets (or, more generally, data messages that may contain one or more data packets and other information), to the antennas 816 for transmission to one or more other devices. The antennas 816 may further receive data messages transmitted from other devices. The antennas 816 may provide the received data messages for processing and/or demodulation at the transceiver 810. The transceiver 810 may provide the demodulated and decoded data (e.g., communication signals, data signals, control signals, machine learning (ML) model monitoring configurations, ML model monitoring requests, instructions to deactivate and/or retrain a ML model, etc.) to the ML model monitoring module 808 for processing. The antennas 816 may include multiple antennas of similar or different designs in order to sustain multiple transmission links.

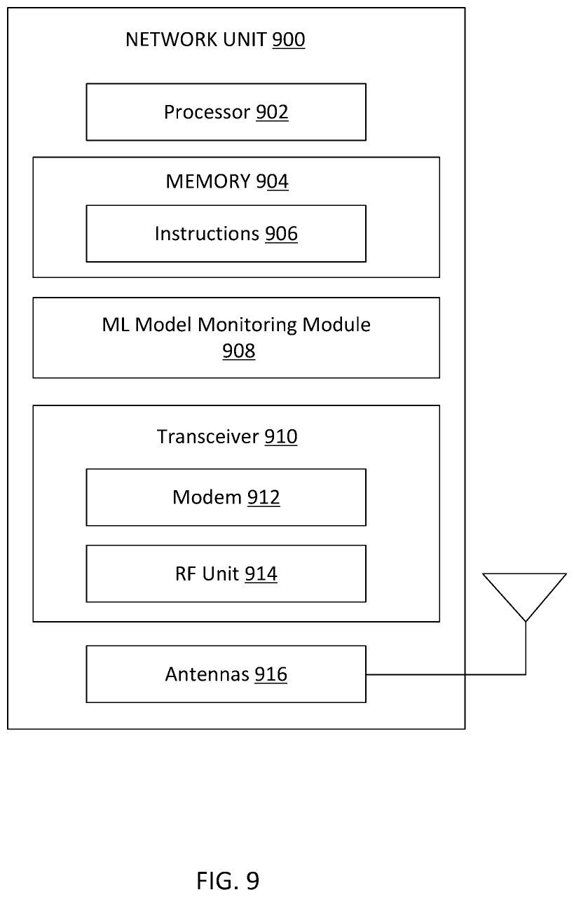

FIG. 9 is a block diagram of a network unit 900 according to one or more aspects of the present disclosure. The network unit 900 may be a BS 105, CU 210, DU 230, and/or RU 240 as discussed in FIGS. 1-7. Accordingly, the network unit 900 may include a BS. The BS may be an aggregated BS or a disaggregated BS, as described above. As shown, the network unit 900 may include a processor 902, a memory 904, a machine learning (ML) monitoring module 908, a transceiver 910 including a modem subsystem 912 and a radio frequency (RF) unit 914, and one or more antennas 916. These elements may be coupled with one another. The term “coupled” may refer to directly or indirectly coupled or connected to one or more intervening elements. For instance, these elements may be in direct or indirect communication with each other, for instance via one or more buses.

The processor 902 may have various features as a specific-type processor. For instance, these may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 902), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, a solid state memory device, one or more hard disk drives, memristor-based arrays, other forms of volatile and non-volatile memory, or a combination of different types of memory. In some aspects, the memory 904 may include a non-transitory computer-readable medium. The memory 904 may store instructions 906. The instructions 906 may include instructions that, when executed by the processor 902, cause the network unit 900 to perform operations described herein, for instance, aspects of FIGS. 3-7 and 11. Instructions 906 may also be referred to as program code. The program code may be for causing a wireless communication device to perform these operations, for instance by causing one or more processors (such as processor 902) to control or command the network unit 900 to do so. The terms “instructions” and “code” should be interpreted broadly to include any type of computer-readable statement(s). For instance, the terms “instructions” and “code” may refer to one or more programs, routines, sub-routines, functions, procedures, etc. “Instructions” and “code” may include a single computer-readable statement or many computer-readable statements.

The ML model monitoring module 908 may be implemented via hardware, software, or combinations thereof. For instance, the ML model monitoring module 908 may be implemented as a processor, circuit, and/or instructions 906 stored in the memory 904 and executed by the processor 902. In some instances, the ML model monitoring module 908 can be integrated within the modem subsystem 912. For instance, the ML model monitoring module 908 can be implemented by a combination of software components (e.g., executed by a DSP or a general processor) and hardware components (e.g., logic gates and circuitry) within the modem subsystem 912. The ML model monitoring module 908 may communicate with one or more components of the network unit 900 to implement various aspects of the present disclosure, for instance, aspects of FIGS. 3-7 and 11.

In some aspects, the ML model monitoring module 908 may be configured, along with other components of the network unit 900, to transmit, to a user equipment (UE), a machine learning (ML) model monitoring configuration. The ML model monitoring configuration may enable the UE to detect a failure of a ML model based on one or more measured values. In some aspects, the ML model monitoring module 908 may be configured, along with other components of the network unit 900, to receive, from the UE, an indication of a failure of the ML model based on the ML model monitoring configuration. In some aspects, the ML model monitoring module 908 may be configured, along with other components of the network unit 900, to set one or more parameters of the ML model monitoring configuration. In some aspects, the ML model monitoring module 908 may be configured, along with other components of the network unit 900, to transmit at least one reference signal for each of a plurality of monitoring occasions associated with the ML model monitoring configuration.

As shown, the transceiver 910 may include the modem subsystem 912 and the RF unit 914. The transceiver 910 can be configured to communicate bi-directionally with other devices, such as the UE 115, UE 800, and/or another network unit. The modem subsystem 912 may be configured to modulate and/or encode data according to a modulation and coding scheme (MCS), e.g., a low-density parity check (LDPC) coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data (e.g., communication signals, data signals, control signals, machine learning (ML) model monitoring configurations, ML model monitoring requests, instructions to deactivate and/or retrain a ML model, etc.) from the modem subsystem 912 (on outbound transmissions). The RF unit 914 may be further configured to perform analog beamforming in conjunction with the digital beamforming. Although shown as integrated together in transceiver 910, the modem subsystem 912, and/or the RF unit 914 may be separate devices that are coupled together at the network unit 900 to enable the network unit 900 to communicate with other devices.

The RF unit 914 may provide the modulated and/or processed data, e.g., data packets (or, more generally, data messages that may contain one or more data packets and other information), to the antennas 916 for transmission to one or more other devices. The antennas 916 may further receive data messages transmitted from other devices and provide the received data messages for processing and/or demodulation at the transceiver 910. The transceiver 910 may provide the demodulated and decoded data (e.g., communication signals, data signals, control signals, capability reports, ML model monitoring reports, ML model failure indications, etc.) to the ML model monitoring module 908 for processing. The antennas 916 may include multiple antennas of similar or different designs in order to sustain multiple transmission links.

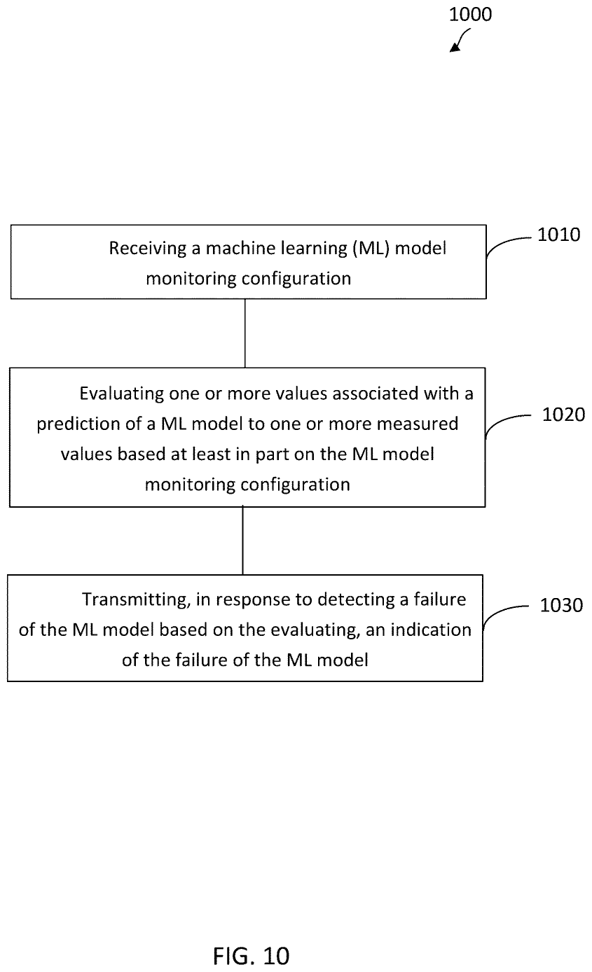

FIG. 10 is a flow diagram illustrating a wireless communication method 1000 according to one or more aspects of the present disclosure. Aspects of the method 1000 can be executed by a computing device (e.g., a processor, processing circuit, and/or other suitable component) of a wireless communication device or other suitable means for performing the blocks. For instance, the wireless communication device may be a UE (e.g., UE 115 or UE 800). The UE may utilize one or more components, such as the processor 802, the memory 804, the ML model monitoring module 808, the transceiver 810, the modem subsystem 812, the RF unit 814, and/or the one or more antennas 816, to execute the blocks of method 1000. The method 1000 may employ similar mechanisms as described in FIGS. 3-7. As illustrated, the method 1000 includes a number of enumerated blocks, but aspects of the method 1000 may include additional blocks before, after, and in between the enumerated blocks. In some aspects, one or more of the enumerated blocks may be omitted or performed in a different order.

At block 1010, the UE (e.g., UE 115 and/or UE 800) receives a machine learning (ML) model monitoring configuration. The UE may receive the ML model monitoring configuration from a network unit (e.g., network unit 900, BS 105, CU 210, DU 230, and/or RU 240). The UE may receive the ML model monitoring configuration from the network unit via a radio resource control (RRC) message or other suitable communication. The ML model monitoring configuration may be included as an information element of the communication.

The ML model monitoring configuration may include one or more parameters associated with ML model monitoring and/or reporting. For example, the ML model monitoring configuration may include an indication of one or more of a ML model failure detection (MFD) timer duration, a maximum number of ML model failure instances (MFIs), one or more values associated with one or more MFI criterion, and/or other parameters associated with ML model monitoring and/or reporting. That is, the ML model monitoring configuration may include an indication of one or more parameters and/or criterion utilized to detect the occurrence of one or more events associated with the ML model. As discussed further below, the UE may utilize information from the ML model monitoring configuration to evaluate the performance of one or more ML models. In some instances, the ML model(s) may include an ML model utilized by the UE for beam prediction. For example, the ML model may be configured to provide a time domain beam prediction (e.g., as discussed with respect to FIG. 3) and/or a spatial domain beam prediction (e.g., as discussed with respect to FIGS. 4 and 5).

At block 1020, the UE evaluates one or more values associated with a prediction of a ML model to one or more measured values. In some aspects, the UE evaluates the value(s) associated with the prediction of the ML model to the measured value(s) based at least in part on the ML model monitoring configuration. In this regard, the UE may utilize information from the ML model monitoring configuration to evaluate the performance of the ML model. For example, the UE may evaluate the one or more values associated with the prediction of the ML model based on an indication of a ML model failure detection (MFD) timer duration, an indication of a maximum number of ML model failure instances (MFIs), an indication of one or more values associated with one or more MFI criterion, and/or the other parameters indicated in the ML model monitoring configuration.

In some aspects, the UE may detect, based on the evaluation, one or more events, such as one or more ML model failure instance(s) (MFIs) and/or the failure of the ML model. In this manner, the UE may detect the event(s) (MFIs and/or the failure of the ML model) based on the ML model monitoring configuration. In some instances, the UE detects an initial MFI based on information from the ML model monitoring configuration. In this regard, the UE may determine whether an MFI criterion is satisfied for each of a plurality of monitoring occasions. In some aspects, the UE determines whether the MFI criterion is satisfied by evaluating the one or more value(s) associated with the prediction of the ML model relative to the one or more measured value(s).

In some instances, the UE evaluates one or more measured values associated with the prediction of the ML model to one or more measured values associated with a group of measured beams. In some instances, the UE may determine whether a top-1 predicted beam of the ML model is included in a set of top-K beams of the group of measured beams. For example, referring back to FIG. 3, the UE may determine whether a measurement (e.g., RSRP (e.g., L1-RSRP), RSRQ, RSSI, SINR, etc.) associated with the top-1 predicted beam of the predicted beam group 315i is within the top-K beams (e.g., top 1, 2, 3, 4, 5, etc. beams) of the group of measured beams of auxiliary reference signal group 320a. In this regard, the measurement associated with the top-1 predicted beam of the predicted beam group 315i may be a measurement of the corresponding beam of the group of measured beams of auxiliary reference signal group 320a. For example, if ML model predicts that a particular beam (e.g., beam index 2) is the top-1 predicted beam, then the measurement of that particular beam (e.g., beam index 2) from the group of measured beams of auxiliary reference signal group 320a may be used as the measurement associated with the top-1 predicted beam of the predicted beam group 315i.

In some instances, the MFI criterion may be satisfied if the top-1 predicted beam of the ML model is not included in the set of top-K beams of the group of measured beams. That is, an MFI is present if the top-1 predicted beam of the ML model is not included in the set of top-K beams of the group of measured beams. For example, if the measurement associated with the top-1 predicted beam (e.g., beam index 2) of the ML model is not included in the top-K (e.g., 1, 2, 3, 4, etc.) beams of the group of measured beams of auxiliary reference signal group 320a, then an MFI is present. On the other hand, if the top-1 predicted beam of the ML model is included in the set of top-K beams of the group of measured beams, then the ML model may be considered to be operating appropriately and an MFI is not present. For example, if the measurement associated with the top-1predicted beam (e.g., beam index 2) of the ML model is included in the top-K (e.g., 1, 2, 3, 4, etc.) beams of the group of measured beams of auxiliary reference signal group 320a, then an MFI is not present.

In some instances, the UE may determine whether a top-1 measured beam of the group of measured beams is included in a set of top-K beams of a group of predicted beams associated with the prediction of the ML model. For example, referring back to FIG. 3, the UE may determine whether a top-1 measured beam from the group of measured beams of auxiliary reference signal group 320a is in the top-K beams (e.g., top 1, 2, 3, 4, 5, etc. beams) of the predicted beam group 315i. The determination of the ranking of the beams may be based on RSRP (e.g., L1-RSRP), RSRQ, RSSI, SINR, etc. In this regard, the measurement of the top-1 measured beam from the group of measured beams of auxiliary reference signal group 320a may be based on the measurements of the beams in the group of measured beams of auxiliary reference signal group 320a. The measurements associated with the top-K predicted beams of the predicted beam group 315i may be measurements of the corresponding beams of the group of measured beams of auxiliary reference signal group 320a. For example, if ML model predicts that particular beams (e.g., beam indexes 2, 3, and 4) are the top-3 predicted beams, then the measurements of those particular beams (e.g., beam indexes 2, 3, and 4) from the group of measured beams of auxiliary reference signal group 320a may be used as the measurements associated with the top-K predicted beams of the predicted beam group 315i.

In some instances, the MFI criterion maybe satisfied if the top-1 measured beam of the group of measured beams is not included in the set of top-K beams of the group of predicted beams associated with the prediction of the ML model. That is, an MFI is present if the top-1 measured beam of the ML model is not included in the set of top-K beams of the group of the predicted beams of the ML model. For example, if the measurement associated with the top-1 measured beam (e.g., beam index 2) of the group of measured beams of auxiliary reference signal group 320a is not included in the top-K (e.g., 1, 2, 3, 4, etc.) beams of the predicted beam group 315 i, then an MFI is present. On the other hand, if the top-1 measured beam of the group of measured beams of auxiliary reference signal group 320a is included in the set of top-K beams of the predicted beam group 315i, then the ML model may be considered to be operating appropriately and an MFI is not present. For example, if the measurement associated with the top-1 measured beam (e.g., beam index 2) of the group of measured beams of auxiliary reference signal group 320a is included in the top-K (e.g., 1, 2, 3, 4, etc.) beams of the predicted beam group 315 i, then an MFI is not present.

In some instances, the UE may determine whether a layer 1 reference signal receive power (L1-RSRP) and/or other measurement(s) (e.g., RSRQ, RSSI, SNIR, etc.) of a top-1 predicted beam of the ML model is within a threshold difference of an L1-RSRP of a top-1 measured beam of the group of measured beams. For example, referring back to FIG. 3, the UE may determine whether the L1-RSRP associated with the top-1 predicted beam of the predicted beam group 315i is within a threshold difference of a measured L1-RSRP of the top-1 beam of the group of measured beams of of auxiliary reference signal group 320a. In this regard, the L1-RSRP associated with the top-1 predicted beam of the predicted beam group 315i may be a measurement of the corresponding beam of the group of measured beams of auxiliary reference signal group 320a. For example, if ML model predicts that a particular beam (e.g., beam index 2) is the top-1 predicted beam, then the measurement of that particular beam (e.g., beam index 2) from the group of measured beams of auxiliary reference signal group 320a may be used as the measurement associated with the top-1 predicted beam of the predicted beam group 315i.

In some instances, the MFI criterion is satisfied if the L1-RSRP and/or other measurement(s) of the top-1 predicted beam of the ML model (e.g., beam index 2) is not within the threshold difference (e.g., 0.5 dB, 1.0 dB, 1.5 dB, or otherwise) of the L 1-RSRP of the top-1 measured beam of the group of measured beams. On the other hand, if the L1-RSRP of the top-1 predicted beam of the ML model is within the threshold difference of the L1-RSRP of the top-1 beam of the group of measured beams, then the ML model may be considered to be operating appropriately and an MFI is not present. In some instances, the UE may receive an indication of the threshold difference from the network unit. In some aspects, the indication of the threshold difference may be included in the ML model monitoring configuration.

In some instances, the UE evaluates one or more predicted values associated with a prediction of the ML model to one or more measured values associated with a group of measured beams. In some instances, the UE determines whether a predicted layer 1 reference signal receive power (L1-RSRP) and/or other measurement(s) (e.g., RSRQ, RSSI, SNIR, etc.) of a top-1 predicted beam of the ML model is within a threshold difference of a measured L1-RSRP of a top-1 measured beam of the group of measured beams. For example, referring back to FIG. 3, the UE may determine whether a predicted L1-RSRP associated with the top-1 predicted beam of the predicted beam group 315i is within a threshold difference of a measured L1-RSRP of the top-1 beam of the group of measured beams of auxiliary reference signal group 320a. In this regard, the L1-RSRP associated with the top-1 predicted beam of the predicted beam group 315i may be a measurement of the corresponding beam of the group of measured beams of auxiliary reference signal group 320a.

In some aspects, the MFI criterion is satisfied if the predicted L1-RSRP of the top-1 predicted beam (e.g., beam index 2) of the ML model is not within the threshold difference (e.g., 0.5 dB, 1.0 dB, 1.5 dB, or otherwise) of the measured L 1-RSRP of the top-1 measured beam of the group of measured beams. On the other hand, if the predicted L1-RSRP of the top-1 predicted beam of the ML model is within the threshold difference of the measured L1-RSRP of the top-1 beam of the group of measured beams, then the ML model may be considered to be operating appropriately and an MFI is not present. In some instances, the UE may receive an indication of the threshold difference between the predicted L1-RSRP and the measured L1-RSRP from the network unit. In some aspects, the indication of the threshold difference between the predicted L1-RSRP and the measured L1-RSRP may be included in the ML model monitoring configuration.

In response to detecting an initial MFI (e.g., based on one or more of the criteria discussed above), the UE may start a ML model failure detection (MFD) timer. In some aspects, the ML model monitoring configuration includes an indication of a duration of the MFD timer. In some aspects, the UE determines that the ML model has failed based on detecting a number of MFIs before the end of the MFD timer. For example, if the UE detects a number of MFIs (e.g., based on one or more of the criteria discussed above) before the expiration of the MFD timer that exceeds a threshold, then the UE may determine the ML model has failed. In this regard, the UE may increment an MFI counter for the initial MFI and/or each of the number of MFIs before the end of the MFD timer. If the MFI counter reaches the threshold, then the UE may determine and/or declare that the ML model has failed. In some instances, the ML model monitoring configuration includes an indication of the threshold (e.g., 2, 3, 4, 5, 6, 7, etc.) number of MFIs associated with a ML model failure.

At block 1030, the UE transmits, in response to detecting a failure of the ML model, an indication of the failure of the ML model. That is, in response to detecting an event, the UE may transmit an indication of the detected event. In some instances, the UE may detect the failure of the ML model based on the evaluating at block 1020. The UE may transmit the indication of the failure of the ML model to the network unit. The UE may transmit the indication of the failure of the ML model via an RRC message, a PUCCH communication, a PUSCH communication, and/or other suitable communication.

In some instances, the UE receives an instruction to deactivate the ML model. For example, the UE may receive from a network unit, in response to UE transmitting the indication of the failure of the ML model, the instruction to deactivate the ML model. In some instances, the UE receives an instruction to retrain the ML model. For example, the UE may receive from a network unit, in response to UE transmitting the indication of the failure of the ML model, the instruction to retrain the ML model.

In some instances, the UE deactivates the ML model based on detecting the failure of the ML model. In some instances, the UE initiates a retraining of the ML model based on detecting the failure of the ML model.

In some instances, the UE may not detect a failure of the ML model based on the evaluating at block 1020. That is, the UE may determine, based on the evaluating at block 1020, that the ML model is operating appropriately. In some aspects, the UE may transmit an indication that the ML model is operating properly to the network unit. For example, the UE may transmit the indication of the ML model working properly to a network unit via an RRC message, a PUCCH communication, a PUSCH communication, and/or other suitable communication.

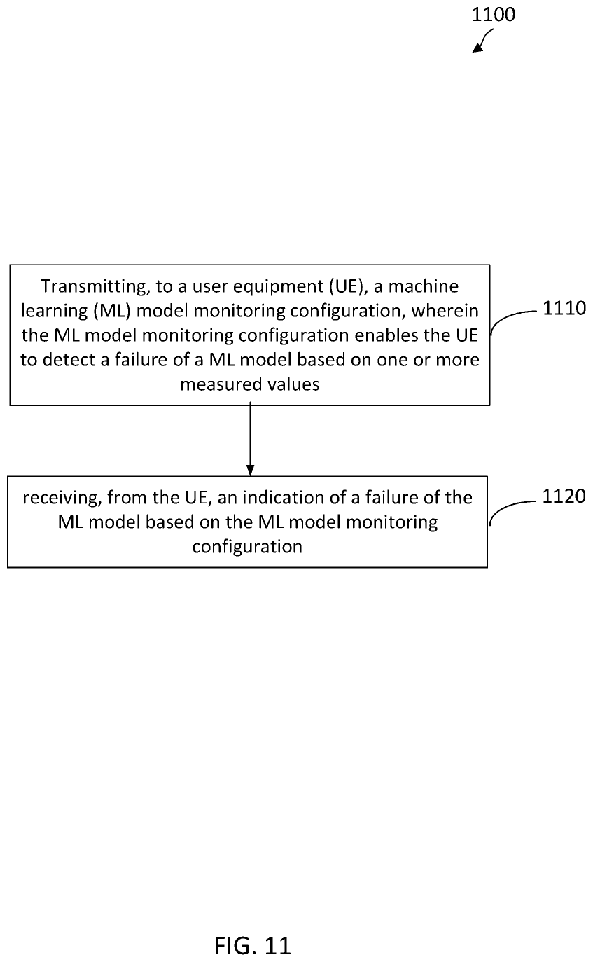

FIG. 11 is a flow diagram illustrating a wireless communication method 1100 according to one or more aspects of the present disclosure. Aspects of the method 1100 can be executed by a computing device (e.g., a processor, processing circuit, and/or other suitable component) of a wireless communication device or other suitable means for performing the blocks. For instance, the wireless communication device may include a network unit (e.g., network unit 900, BS 105, CU 210, DU 230, and/or RU 240). The network unit 900 may utilize one or more components, such as the processor 902, the memory 904, the ML model monitoring module 908, the transceiver 910, the modem subsystem 912, the RF unit 914, and/or the one or more antennas 916, to execute the blocks of method 1100. The method 1100 may employ similar mechanisms as described in FIGS. 3-7. As illustrated, the method 1100 includes a number of enumerated blocks, but aspects of the method 1100 may include additional blocks before, after, and in between the enumerated blocks. In some aspects, one or more of the enumerated blocks may be omitted or performed in a different order.

At block 1110, the network unit (network unit 900, BS 105, CU 210, DU 230, and/or RU 240) transmits a machine learning (ML) model monitoring configuration. The network unit may transmit the ML model monitoring configuration to a user equipment (UE) (e.g., UE 115 and/or UE 800). The network unit may transmit the ML model monitoring configuration to the UE via a radio resource control (RRC) message or other suitable communication. The network unit may include the ML model monitoring configuration as an information element of the communication. The ML model monitoring configuration may enable the UE to monitor performance of a ML model based on one or more measured values, including detecting a failure of the ML model.

The ML model monitoring configuration may include one or more parameters associated with ML model monitoring and/or reporting. For example, the ML model monitoring configuration may include an indication of one or more of a ML model failure detection (MFD) timer duration, a maximum number of ML model failure instances (MFIs), one or more values associated with one or more MFI criterion (e.g., whether a top-1 predicted beam of the ML model is included in a set of top-K beams of a group of measured beams, whether a top-1 measured beam of a group of measured beams is included in a set of top-K beams of a group of predicted beams of the ML model, whether a layer 1 reference signal receive power (L1-RSRP) or other measurement(s) of a top-1 predicted beam of the ML model is within a threshold difference of an L1-RSRP or other measurement(s) of a top-1 measured beam of a group of measured beams, whether a predicted layer 1 reference signal receive power (L1-RSRP) or other measurement(s) of a top-1 predicted beam of the ML model is within a threshold difference of a measured L1-RSRP or other measurement(s) of a top-1 measured beam of a group of measured beams, etc.) and/or other parameters associated with ML model monitoring and/or reporting. In this regard, the network unit may set one or more of the parameters included in the ML model monitoring configuration based on network conditions (e.g., traffic patterns, network loads, latency requirements, etc.), network capability, UE capability, and/or other factors. That is, the ML model monitoring configuration may include an indication of one or more parameters and/or criterion utilized to detect the occurrence of one or more events associated with the ML model. The UE may utilize information from the ML model monitoring configuration to evaluate the performance of one or more ML models, including reporting an indication of the performance to the network unit in some instances.

At block 1120, the network unit receives an indication of a failure of the ML model from a UE. That is, the network unit may receive an indication of an event detected by the UE. In some instances, the indication of the failure of the ML model is received based on the ML model monitoring configuration. In this regard, the UE may determine the ML model has failed based on one or more of the parameters indicated in the ML model monitoring configuration and, in response, transmit the indication of the failure to the network unit.

In some aspects, the network unit transmits at least one reference signal for each of a plurality of monitoring occasions associated with the ML model monitoring configuration. For example, the network unit may transmit reference signal(s) (e.g., downlink reference signals, CSI-RS, CRS, SSB, etc.) associated with a plurality of monitoring occasions as described above with respect to FIGS. 3-5. In this regard, the network unit may transmit nominal reference signals (e.g., 305, 405, 505) and/or auxiliary reference signals (e.g., 320, 420, 520) during normal operation and/or during a ML model evaluation period (e.g., 335, 435, 535).

In some instances, the network unit transmits an instruction to the UE to deactivate the ML model. For example, the network unit may, in response to receiving the indication of the failure of the ML model from the UE, transmit the instruction to deactivate the ML model. In some instances, the network unit transmits an instruction to retrain the ML model. For example, the network unit may, in response to receiving the indication of the failure of the ML model from the UE, transmit the instruction to retrain the ML model.

Other aspects of the present disclosure include:

Clause 1. A method of wireless communication performed by a user equipment, the method comprising:
receiving a machine learning (ML) model monitoring configuration;
evaluating one or more values associated with a prediction of a ML model to one or more measured values based at least in part on the ML model monitoring configuration; and
transmitting, in response to detecting a failure of the ML model based on the evaluating, an indication of the failure of the ML model.

Clause 2. The method of clause 1, further comprising:
detecting the failure of the ML model based on the ML model monitoring configuration.

Clause 3. The method of clause 2, wherein the detecting the failure of the ML model based on the ML model monitoring configuration comprises:
starting a ML model failure detection (MFD) timer in response to detecting an initial ML model failure instance (MFI).

Clause 4. The method of clause 3, wherein the ML model monitoring configuration includes an indication of a duration of the MFD timer.

Clause 5. The method of clause 3, wherein the detecting the failure of the ML model based on the ML model monitoring configuration further comprises:
detecting a number of MFIs before an end of the MFD timer, wherein the number of MFIs satisfies a threshold.

Clause 6. The method of clause 5, wherein the detecting the failure of the ML model based on the ML model monitoring configuration further comprises:
incrementing an MFI counter for the initial MFI and each of the number of MFIs before the end of the MFD timer.

Clause 7. The method of clause 5, wherein the ML model monitoring configuration includes an indication of the threshold.

Clause 8. The method of clause 2, wherein the detecting the failure of the ML model based on the ML model monitoring configuration comprises:
determining whether a ML model failure instance (MFI) criterion is satisfied for each of a plurality of monitoring occasions based on the evaluating.

Clause 9. The method of clause 8, wherein the evaluating comprises:
evaluating one or more measured values associated with the prediction of the ML model to one or more measured values associated with a group of measured beams.

Clause 10. The method of clause 9, wherein the evaluating the one or more measured values associated with the prediction of the ML model to the one or more measured values associated with the group of measured beams comprises:
determining whether a top-1 predicted beam of the ML model is included in a set of top-K beams of the group of measured beams; and
wherein the MFI criterion is satisfied if the top-1 predicted beam of the ML model is not included in the set of top-K beams of the group of measured beams.

Clause 11. The method of clause 9, wherein the evaluating the one or more measured values associated with the prediction of the ML model to the one or more measured values associated with the group of measured beams comprises:
determining whether a top-1 measured beam of the group of measured beams is included in a set of top-K beams of a group of predicted beams associated with the prediction of the ML model; and
wherein the MFI criterion is satisfied if the top-1 measured beam of the group of measured beams is not included in the set of top-K beams of the group of predicted beams associated with the prediction of the ML model.

Clause 12. The method of clause 9, wherein the evaluating the one or more measured values associated with the prediction of the ML model to the one or more measured values associated with the group of measured beams comprises:
determining whether a layer 1 reference signal receive power (L1-RSRP) of a top-1 predicted beam of the ML model is within a threshold difference of an L1-RSRP of a top-1 measured beam of the group of measured beams; and
wherein the MFI criterion is satisfied if L1-RSRP of the top-1 predicted beam of the ML model is not within the threshold difference of the L1-RSRP of the top-1 measured beam of the group of measured beams.

Clause 13. The method of clause 8, wherein the evaluating comprises:
evaluating one or more predicted values associated with the prediction of the ML model to one or more measured values associated with a group of measured beams.

Clause 14. The method of clause 13, wherein the evaluating the one or more predicted values associated with the prediction of the ML model to the one or more measured values associated with the group of measured beams comprises:
determining whether a predicted layer 1 reference signal receive power (L1-RSRP) of a top-1 predicted beam of the ML model is within a threshold difference of a measured L1-RSRP of a top-1 measured beam of the group of measured beams; and
wherein the MFI criterion is satisfied if the predicted L1-RSRP of the top-1 predicted beam of the ML model is not within the threshold difference of the measured L1-RSRP of the top-1 measured beam of the group of measured beams.

Clause 15. The method of any of clauses 1-14, wherein the receiving the ML model monitoring configuration comprises:
receiving the ML model monitoring configuration from a network unit via a radio resource control (RRC) message.

Clause 16. The method of any of clauses 1-15, wherein the receiving the ML model monitoring configuration comprises:
receiving the ML model monitoring configuration including an indication of one or more of:
   a ML model failure detection (MFD) timer duration;
   a maximum number of ML model failure instances (MFIs); or
   one or more values associated with an MFI criterion.

Clause 17. The method of any of clauses 1-16, further comprising at least one of:
deactivating the ML model based on detecting the failure of the ML model; or
initiating a retraining of the ML model based on detecting the failure of the ML model.

Clause 18. The method of any of clauses 1-17, further comprising:
receiving, from a network unit based on the indication of the failure of the ML model, at least one of:
   an instruction to deactivate the ML model; or
   an instruction to retrain the ML model.

Clause 19. A method of wireless communication performed by a network unit, the method comprising:
transmitting, to a user equipment (UE), a machine learning (ML) model monitoring configuration, wherein the ML model monitoring configuration enables the UE to detect a failure of a ML model based on one or more measured values; and
receiving, from the UE, an indication of a failure of the ML model based on the ML model monitoring configuration.

Clause 20. The method of clause 19, further comprising:
setting one or more parameters of the ML model monitoring configuration.

Clause 21. The method of clause 20, wherein the one or more parameters of the ML model monitoring configuration includes a duration of a ML model failure detection (MFD) timer.

Clause 22. The method of clause 20, wherein the one or more parameters of the ML model monitoring configuration includes a maximum number of ML model failure instances (MFIs).

Clause 23. The method of clause 20, wherein the one or more parameters of the ML model monitoring configuration includes one or more values associated with an ML model failure instance (MFI) criterion.

Clause 24. The method of clause 23, wherein the MFI criterion is based on whether a top-1 predicted beam of the ML model is included in a set of top-K beams of a group of measured beams.

Clause 25. The method of clause 23, wherein the MFI criterion is based on whether a top-1 measured beam of a group of measured beams is included in a set of top-K beams of a group of predicted beams of the ML model.

Clause 26. The method of clause 23, wherein the MFI criterion is based on whether a layer 1 reference signal receive power (L1-RSRP) of a top-1 predicted beam of the ML model is within a threshold difference of an L1-RSRP of a top-1 measured beam of a group of measured beams.

Clause 27. The method of clause 23, wherein the MFI criterion is based on whether a predicted layer 1 reference signal receive power (L1-RSRP) of a top-1 predicted beam of the ML model is within a threshold difference of a measured L1-RSRP of a top-1 measured beam of a group of measured beams.

Clause 28. The method of any of clauses 19-27, further comprising:
transmitting at least one reference signal for each of a plurality of monitoring occasions associated with the ML model monitoring configuration.

Clause 29. The method of any of clauses 19-28, wherein the transmitting the ML model monitoring configuration comprises:
transmitting the ML model monitoring configuration via a radio resource control (RRC) message.

Clause 30. The method of any of clauses 19-29, further comprising:
transmitting, to the UE based on the indication of the failure of the ML model, at least one of:
   an instruction to deactivate the ML model; or
   an instruction to retrain the ML model.

Clause 31. A non-transitory computer-readable medium storing one or more instructions for wireless communication, the one or more instructions comprising one or more instructions that, when executed by one or more processors of a UE, cause the UE to perform any one of clauses 1-18.

Clause 32. A non-transitory computer-readable medium storing one or more instructions for wireless communication, the one or more instructions comprising one or more instructions that, when executed by one or more processors of a network unit, cause the network unit to perform any one of aspects of aspects of clauses 19-30.

Clause 33. A user equipment (UE) comprising one or more means to perform any one or more aspects of clauses 1-18.

Clause 34. A network unit comprising one or more means to perform any one or more aspects of clauses 19-30.

Clause 35. A user equipment (UE) comprising: a memory; a transceiver; and at least one processor coupled to the memory and the transceiver, wherein the UE is configured to perform any one or more aspects of clauses 1-18.

Clause 36. A network unit comprising: a memory; a transceiver; and at least one processor coupled to the memory and the transceiver, wherein the network unit is configured to perform any one or more aspects of clauses 19-30.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other aspects and implementations are within the scope of the disclosure and appended claims. For instance, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for instance, a list of items prefaced by a phrase such as “at least one of” or “one or more of”) indicates an inclusive list such that, for instance, a list of [at least one of A, B, or C] means A or B or C or AB or AC or BC or ABC (e.g., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some aspects thereof, but rather, should be fully commensurate with that of the claims appended hereafter and their functional equivalents.

1. A method of wireless communication performed by a user equipment, the method comprising:
receiving a machine learning (ML) model monitoring configuration;
evaluating one or more values associated with a prediction of a ML model to one or more measured values based at least in part on the ML model monitoring configuration; and
transmitting, in response to detecting a failure of the ML model based on the evaluating, an indication of the failure of the ML model.

2. The method of claim 1, further comprising:
detecting the failure of the ML model based on the ML model monitoring configuration.

3. The method of claim 2, wherein the detecting the failure of the ML model based on the ML model monitoring configuration comprises:
starting a ML model failure detection (MFD) timer in response to detecting an initial ML model failure instance (MFI).

4. The method of claim 3, wherein the ML model monitoring configuration includes an indication of a duration of the MFD timer.

5. The method of claim 3, wherein the detecting the failure of the ML model based on the ML model monitoring configuration further comprises:
detecting a number of MFIs before an end of the MFD timer, wherein the number of MFIs satisfies a threshold.

6. The method of claim 5, wherein the detecting the failure of the ML model based on the ML model monitoring configuration further comprises:
incrementing an MFI counter for the initial MFI and each of the number of MFIs before the end of the MFD timer.

7. The method of claim 5, wherein the ML model monitoring configuration includes an indication of the threshold.

8. The method of claim 2, wherein the detecting the failure of the ML model based on the ML model monitoring configuration comprises:
determining whether a ML model failure instance (MFI) criterion is satisfied for each of a plurality of monitoring occasions based on the evaluating.

9. The method of claim 8, wherein the evaluating comprises:
evaluating one or more measured values associated with the prediction of the ML model to one or more measured values associated with a group of measured beams.

10. The method of claim 9, wherein the evaluating the one or more measured values associated with the prediction of the ML model to the one or more measured values associated with the group of measured beams comprises:
determining whether a top-1 predicted beam of the ML model is included in a set of top-K beams of the group of measured beams; and
wherein the MFI criterion is satisfied if the top-1 predicted beam of the ML model is not included in the set of top-K beams of the group of measured beams.

11. The method of claim 9, wherein the evaluating the one or more measured values associated with the prediction of the ML model to the one or more measured values associated with the group of measured beams comprises:
determining whether a top-1 measured beam of the group of measured beams is included in a set of top-K beams of a group of predicted beams associated with the prediction of the ML model; and
wherein the MFI criterion is satisfied if the top-1 measured beam of the group of measured beams is not included in the set of top-K beams of the group of predicted beams associated with the prediction of the ML model.

12. The method of claim 9, wherein the evaluating the one or more measured values associated with the prediction of the ML model to the one or more measured values associated with the group of measured beams comprises:
determining whether a layer 1 reference signal receive power (L1-RSRP) of a top-1 predicted beam of the ML model is within a threshold difference of an L1-RSRP of a top-1 measured beam of the group of measured beams; and
wherein the MFI criterion is satisfied if L1-RSRP of the top-1 predicted beam of the ML model is not within the threshold difference of the L1-RSRP of the top-1 measured beam of the group of measured beams.

13. The method of claim 8, wherein the evaluating comprises:
evaluating one or more predicted values associated with the prediction of the ML model to one or more measured values associated with a group of measured beams.

14. The method of claim 13, wherein the evaluating the one or more predicted values associated with the prediction of the ML model to the one or more measured values associated with the group of measured beams comprises:
determining whether a predicted layer 1 reference signal receive power (L1-RSRP) of a top-1 predicted beam of the ML model is within a threshold difference of a measured L1-RSRP of a top-1 measured beam of the group of measured beams; and
wherein the MFI criterion is satisfied if the predicted L1-RSRP of the top-1 predicted beam of the ML model is not within the threshold difference of the measured L1-RSRP of the top-1 measured beam of the group of measured beams.

15. The method of claim 1, wherein the receiving the ML model monitoring configuration comprises:
receiving the ML model monitoring configuration from a network unit via a radio resource control (RRC) message.

16. The method of claim 1, wherein the receiving the ML model monitoring configuration comprises:
receiving the ML model monitoring configuration including an indication of one or more of:
a ML model failure detection (MFD) timer duration;
a maximum number of ML model failure instances (MFIs); or
one or more values associated with an MFI criterion.

17. The method of claim 1, further comprising at least one of:
deactivating the ML model based on detecting the failure of the ML model; or initiating a retraining of the ML model based on detecting the failure of the ML model.

18. The method of claim 1, further comprising:
receiving, from a network unit based on the indication of the failure of the ML model, at least one of:
an instruction to deactivate the ML model; or
an instruction to retrain the ML model.

19. A method of wireless communication performed by a network unit, the method comprising:
transmitting, to a user equipment (UE), a machine learning (ML) model monitoring configuration, wherein the ML model monitoring configuration enables the UE to detect a failure of a ML model based on one or more measured values; and
receiving, from the UE, an indication of a failure of the ML model based on the ML model monitoring configuration.

20. The method of claim 19, further comprising:
setting one or more parameters of the ML model monitoring configuration.

21. The method of claim 20, wherein the one or more parameters of the ML model monitoring configuration includes a duration of a ML model failure detection (MFD) timer.

22. The method of claim 20, wherein the one or more parameters of the ML model monitoring configuration includes a maximum number of ML model failure instances (MFIs).

23. The method of claim 20, wherein the one or more parameters of the ML model monitoring configuration includes one or more values associated with an ML model failure instance (MFI) criterion.

24. The method of claim 23, wherein the MFI criterion is based on whether a top-1 predicted beam of the ML model is included in a set of top-K beams of a group of measured beams.

25. The method of claim 23, wherein the MFI criterion is based on whether a top-1 measured beam of a group of measured beams is included in a set of top-K beams of a group of predicted beams of the ML model.

26. The method of claim 23, wherein the MFI criterion is based on whether a layer 1 reference signal receive power (L1-RSRP) of a top-1 predicted beam of the ML model is within a threshold difference of an L1-RSRP of a top-1 measured beam of a group of measured beams.

27. The method of claim 23, wherein the MFI criterion is based on whether a predicted layer 1 reference signal receive power (L1-RSRP) of a top-1 predicted beam of the ML model is within a threshold difference of a measured L1-RSRP of a top-1 measured beam of a group of measured beams.

28. The method of claim 19, further comprising:
transmitting at least one reference signal for each of a plurality of monitoring occasions associated with the ML model monitoring configuration.

29. The method of claim 19, wherein the transmitting the ML model monitoring configuration comprises:
transmitting the ML model monitoring configuration via a radio resource control (RRC) message.

30. The method of claim 19, further comprising:
transmitting, to the UE based on the indication of the failure of the ML model, at least one of:
an instruction to deactivate the ML model; or
an instruction to retrain the ML model.

31. A user equipment (UE), comprising:
a memory device;
a transceiver; and
a processor in communication with the processor and the transceiver, wherein the UE is configured to:
receive a machine learning (ML) model monitoring configuration;
evaluate one or more values associated with a prediction of a ML model to one or more measured values based at least in part on the ML model monitoring configuration; and
transmit, in response to detecting a failure of the ML model based on the evaluating, an indication of the failure of the ML model.

32. The UE of claim 31, wherein the UE is further configured to:
detect the failure of the ML model based on the ML model monitoring configuration.

33. The UE of claim 32, wherein the UE is further configured to:
start a ML model failure detection (MFD) timer in response to detecting an initial ML model failure instance (MFI); and
detect a number of MFIs before an end of the MFD timer, wherein the number of MFIs satisfies a threshold.

34. The UE of claim 33, wherein the UE is further configured to:
increment an MFI counter for the initial MFI and each of the number of MFIs before the end of the MFD timer.

35. The UE of claim 32, wherein UE is further configured to:
determine whether a ML model failure instance (MFI) criterion is satisfied for each of a plurality of monitoring occasions based on the ML model monitoring configuration.

36. The UE of claim 35, wherein the UE is further configured to:
evaluate one or more measured values associated with the prediction of the ML model to one or more measured values associated with a group of measured beams based on at least one of:
determining whether a top-1 predicted beam of the ML model is included in a set of top-K beams of the group of measured beams;
determining whether a top-1 measured beam of the group of measured beams is included in a set of top-K beams of a group of predicted beams associated with the prediction of the ML model; or
determining whether a layer 1 reference signal receive power (L1-RSRP) of a top-1 predicted beam of the ML model is within a threshold difference of an L1-RSRP of a top-1 measured beam of the group of measured beams.

37. The UE of claim 35, wherein the UE is further configured to:
evaluate one or more predicted values associated with the prediction of the ML model to one or more measured values associated with a group of measured beams based on determining whether a predicted layer 1 reference signal receive power (L1-RSRP) of a top-1 predicted beam of the ML model is within a threshold difference of a measured L1-RSRP of a top-1 measured beam of the group of measured beams.

38. The UE of claim 31, wherein the UE is further configured to:
deactivate the ML model based on detecting the failure of the ML model; or
initiate a retraining of the ML model based on detecting the failure of the ML model.

39. The UE of claim 31, wherein the UE is further configured to:
receive, from a network unit based on the indication of the failure of the ML model, at least one of:
an instruction to deactivate the ML model; or
an instruction to retrain the ML model.

40. A network unit, comprising:
a memory device;
a transceiver; and
a processor in communication with the processor and the transceiver, wherein the network unit is configured to:
transmit, to a user equipment (UE), a machine learning (ML) model monitoring configuration, wherein the ML model monitoring configuration enables the UE to detect a failure of a ML model based on one or more measured values; and
receive, from the UE, an indication of a failure of the ML model based on the ML model monitoring configuration.

41. The network unit of claim 40, wherein the network unit is further configured to:
set one or more parameters of the ML model monitoring configuration, wherein the one or more parameters of the ML model monitoring configuration includes at least one of:
a duration of a MFD timer;
a maximum number of ML model failure instances (MFIs); or one or more values associated with an MFI criterion.

42. The network unit of claim 41, wherein:
the one or more parameters of the ML model monitoring configuration includes one or more values associated with the MFI criterion; and
the MFI criterion is based on at least one of:
whether a top-1 predicted beam of the ML model is included in a set of top-K beams of a group of measured beams;
whether a top-1 measured beam of a group of measured beams is included in a set of top-K beams of a group of predicted beams of the ML model;
whether a layer 1 reference signal receive power (L1-RSRP) of a top-1 predicted beam of the ML model is within a threshold difference of an L1-RSRP of a top-1 measured beam of a group of measured beams; or
whether a predicted layer 1 reference signal receive power (L1-RSRP) of a top-1 predicted beam of the ML model is within a threshold difference of a measured L1-RSRP of a top-1 measured beam of a group of measured beams.

43. The network unit of claim 40, wherein the network unit is further configured to:
transmit, to the UE based on the indication of the failure of the ML model, at least one of:
an instruction to deactivate the ML model; or
an instruction to retrain the ML model.
